(19) United States
(12) Patent Application Publication
(10) Pub. No.: US 2026/0302325 A1
(43) Pub. Date: Oct. 1, 2026

(54) SILICON-CONTAINING LITHIUM-ION BATTERIES

(71) Applicant: Graphenix Development, Inc., Williamsville, NY (US)

(72) Inventors: Robert G. Anstey, Tonawanda, NY (US); Alexander J. Warren, Lake View, NY (US); Juan Jose Diaz Leon, Olten (CH); John C. Brewer, Rochester, NY (US); Terrence R. O'Toole, Webster, NY (US)

(73) Assignee: Graphenix Development, Inc., Williamsville, NY (US)

(21) Appl. No.: 19/478,320

(22) PCT Filed: Apr. 25, 2024
(86) PCT No.: PCT/US2024/026315

§ 371 Date: Oct. 24, 2025

Related U.S. Application Data
(60) Provisional application No. 63/498,400, filed on Apr. 26, 2023.

(51) Int. Cl. H01M 10/0525; H01M 4/02; H01M 4/04; H01M 4/134; H01M 4/38; H01M 4/66; H01M 50/119; H01M 50/133; H01M 50/586

(52) U.S. Cl. CPC H01M 10/0525; H01M 4/0404; H01M 4/0423; H01M 4/0428; H01M 4/134; H01M 4/386; H01M 4/661; H01M 4/667; H01M 50/119; H01M 50/133; H01M 50/586; H01M 2004/021; H01M 2004/027; H01M 2004/028

(57) ABSTRACT

A lithium-ion battery cell includes an electrode assembly having an anode and a cathode. The anode includes an anode current collector and a first silicon-containing anode active material layer disposed on a first side of the anode current collector, where the first silicon-containing anode active material layer includes at least 85 atomic % silicon. The cathode includes a cathode current collector and a first cathode active material layer disposed on a first side of the cathode current collector, where the first side of the cathode current collector is proximal to the first side of the anode current collector. The battery cell further includes a lithium-ion electrolyte disposed between the anode and cathode, and a battery cell housing containing the electrode assembly and the electrolyte. During an electrochemical charging event, the first cathode active material layer is compressible to less than 95% of its thickness prior to the charging event.

### CROSS-REFERENCES TO RELATED APPLICATIONS

This application claims the benefit of priority of U.S. Provisional Application No. 63/498,400 filed Apr. 26, 2023, the entire contents of which is incorporated by reference in its entirety for all purposes.

### TECHNICAL FIELD

The present disclosure relates to lithium-ion battery cells.

### BACKGROUND

Silicon has been proposed for lithium-ion batteries to replace the conventional graphite-based anodes, which have a storage capacity that is limited to ~370 mAh/g. Silicon readily alloys with lithium and has a much higher theoretical storage capacity (~3600 to 4200 mAh/g at room temperature) than carbon (graphite) anodes. However, insertion and extraction of lithium into the silicon matrix causes significant volume expansion (>300%) and contraction. This can result in rapid pulverization of the silicon into small particles and electrical disconnection from the current collector. Such expansion can also degrade the structural integrity of the lithium-ion battery cell housing leading to cell failure or even rupture. As a result, if silicon is used at all in the anode, it is typically added to conventional graphite at just a few weight percent.

Despite research into various approaches, batteries based primarily on silicon have yet to make a large market impact due to unresolved problems.

### SUMMARY

There remains a desire for lithium-ion battery cells that can withstand the expansion of silicon-based anodes, while still retaining many of the benefits that silicon provides to the cell.

In accordance with embodiments of this disclosure, a lithium-ion battery cell includes an electrode assembly having an anode, a cathode, and optionally a first separator. The anode includes an anode current collector and a first silicon-containing anode active material layer disposed on a first side of the anode current collector, wherein the first silicon-containing anode active material layer includes at least 85 atomic % silicon. The cathode includes a cathode current collector and a first cathode active material layer disposed on a first side of the cathode current collector, wherein the first side of the cathode current collector is proximal to the first side of the anode current collector. The optional first separator is disposed between the first cathode active material layer and the first anode active material layer. The battery cell further includes a lithium-ion-containing electrolyte disposed between, and in contact with, the anode and cathode. The electrolyte may be in contact with any specific component of the anode and cathode. The battery cell includes a housing containing the electrode assembly and the electrolyte, wherein the housing includes a positive battery terminal in electrical communication with the cathode and a negative battery terminal in electrical communication with the anode.

In accordance with some embodiments, the battery cell may include a compressible separator, a compressible cathode active material layer, a compressible current collector, a compressible central element, a compressible liner, an electrolyte reservoir, or a high porosity silicon-containing anode active material, or any combination thereof.

The present disclosure provides lithium-ion battery cells that may have one or more of at least the following advantages relative to conventional lithium-ion battery cells: longer cell life, improved safety, reduced cell pressure buildup, higher gravimetric charge capacity, higher volumetric charge capacity, improved stability at aggressive ≥1 C charging and/or discharging rates, improved low temperature performance, improved physical durability, simplified manufacturing process, more reproducible manufacturing process; reduced environmental impact manufacturing process, or reduced dimensional changes during operation.

### BRIEF DESCRIPTION OF DRAWINGS

FIG. 1A is a cross-sectional view of a non-limiting example of an anode according to some embodiments.

FIGS. 1B and 1C are plan views of an anode where cutline A-A may represent the cross-section shown in FIG. 1A.

FIG. 2A is a cross-sectional view of a non-limiting example of a cathode according to some embodiments.

FIGS. 2B and 2C are plan views of a cathode where cutline A-A may represent the cross-section shown in FIG. 2A.

FIG. 3A is a cross-sectional view of a non-limiting example of a multilayer electrode assembly according to some embodiments.

FIG. 3B shows a rotated view from FIG. 3A.

FIG. 4 is a non-limiting example of a cylindrical battery cell according to some embodiments.

FIG. 5A is a perspective, expanded view of non-limiting example of a prismatic cell according to some embodiments.

FIG. 5B is a simplified cross-sectional schematic of the prismatic cell cut along the X-Y plane of a prism cell like that of FIG. 5A.

FIG. 6A is a cross-sectional schematic of an anode according to some embodiments.

FIG. 6B shows a cross-sectional view of an anode that includes some non-limiting examples of lithium storage nanostructures.

FIG. 7 is a cross-sectional view of a two-sided anode according to some embodiments.

FIGS. 8A-8C are cross-sectional views of a compressible element according to various embodiments.

FIGS. 9A-9F are cross-sectional schematics of a portion of a battery cell having a compressible separator according to various embodiments.

FIG. 10 is a cross-sectional schematic of an electrode having a compressible current collector according to some embodiments.

FIG. 11 is a cross-sectional schematic of a portion of a battery cell having a compressible cathode active material layer according to some embodiments.

FIG. 12 is a cross-sectional schematic of a portion of a solid-state battery cell according to some embodiments.

### DETAILED DESCRIPTION

It is to be understood that the drawings are for purposes of illustrating the concepts of the disclosure and may not be to scale. Terms like “overlaying”, “over” or the like include, but do not necessarily require, direct contact (unless such direct contact is noted or clearly required for functionality). Herein, an “average” may represent a mean, median, or mode, and an “average thickness” may be based on at least three measurements (e.g., 3, 4, 5, 6, 7, 8, 9, 10, or more measurements). Additional details of certain embodiments of the present application may be found in U.S. Application Publication No. 2019/0267631, U.S. Application Publication No. 2020/0411851, U.S. Application Publication No. 2021/0050584, U.S. Application Publication No. 2021/0057733, U.S. Application Publication No. 2021/0057757, U.S. Application Publication No. 2021/0057755, U.S. Application Publication No. 2021/0066702, PCT International Publication Number WO2022/005999, PCT International Publication Number WO2021/207357, PCT Application No. PCT/US2021/064018, U.S. Patent Application Publication No. 2022/0344627, PCT Application No. PCT/US2022/053321, PCT Application No. PCT/US2023/024254, PCT Application No. PCT/US2023/025773, PCT Application No. PCT/US2024/015578, and PCT Application No. PCT/US2024/015585, the entire contents of which are incorporated herein by reference for all uses.

Lithium-ion battery cells generally include at least one anode, at least one cathode, at least one separator (if the electrolyte is a liquid) provided between the anode and cathode, and a nonaqueous lithium-ion electrolyte disposed between and in contact with the anode and cathode. These components, sometimes referred to as an electrode assembly, are provided in a battery cell housing, which typically includes a positive battery terminal for external connection to the cathode and a negative battery terminal for external connection to the anode.

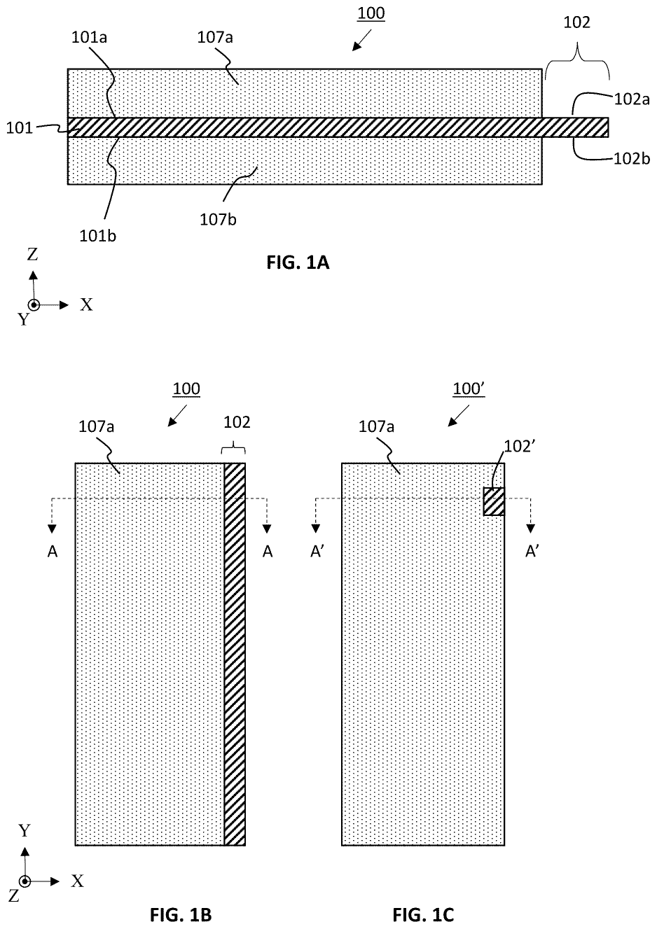

FIG. 1A is a cross-sectional view of a non-limiting example of an anode according to some embodiments. Anode 100 includes an anode current collector 101. A first silicon-containing anode active material layer 107a is provided on a first side 101a of the anode current collector. A second silicon-containing anode active material layer 107b is provided on a second side 101b of the anode current collector. In some embodiments, at least one of the anode active material layers includes at least 85 atomic % silicon deposited, for example, by a PVD or CVD process. The second silicon-containing anode active material layer may be substantially the same as, or alternatively different from, the first silicon-containing active material layer with respect to chemical composition or physical properties (thickness, porosity, or the like). As used herein, “substantially the same” may in some cases refer to when a metric describing one component is within 5% of a corresponding metric of some comparative component. A metric may include and not limited to height, width, molecular weight, density, position, or orientation.

The anode current collector may include an electrical contact area 102 that is free of anode active material, e.g., where anode active material has been removed or deposition has been prevented. As shown, anode contact area 102 may include contact area 102a on the first side of the anode current collector and contact area 102b on the second side of the anode current collector. In some other embodiments, only one side is free of anode active material. As discussed elsewhere, the contact area may engage directly with a battery terminal element, or alternatively, may represent a region to which a tab element (not shown) may be bonded, and the tab element engages with the battery terminal element. A battery terminal element is an electrically conductive structure in the cell that aids in establishing electrical communication between the current collector and the intended battery terminal.

FIG. 1B is a plan view of anode 100 where cutline A-A may represent the cross-section shown in FIG. 1A. As shown, the contact area 102 may correspond to an edge area of the anode current collector extending along the length of the anode (Y-axis). In some embodiments (not illustrated), the contact area may extend along the short side of the anode (X-axis), typically in conjunction with the use of tab elements. FIG. 1C is a plan view of anode 100′ where cutline A′-A′ may correspond to the cross-section of FIG. 1A. Anode 100′ may be similar to anode 100 except that the contact area 102′ is confined to a localized edge area of the anode current collector, not along the entire length. Such a configuration may typically be used in conjunction with a tab element.

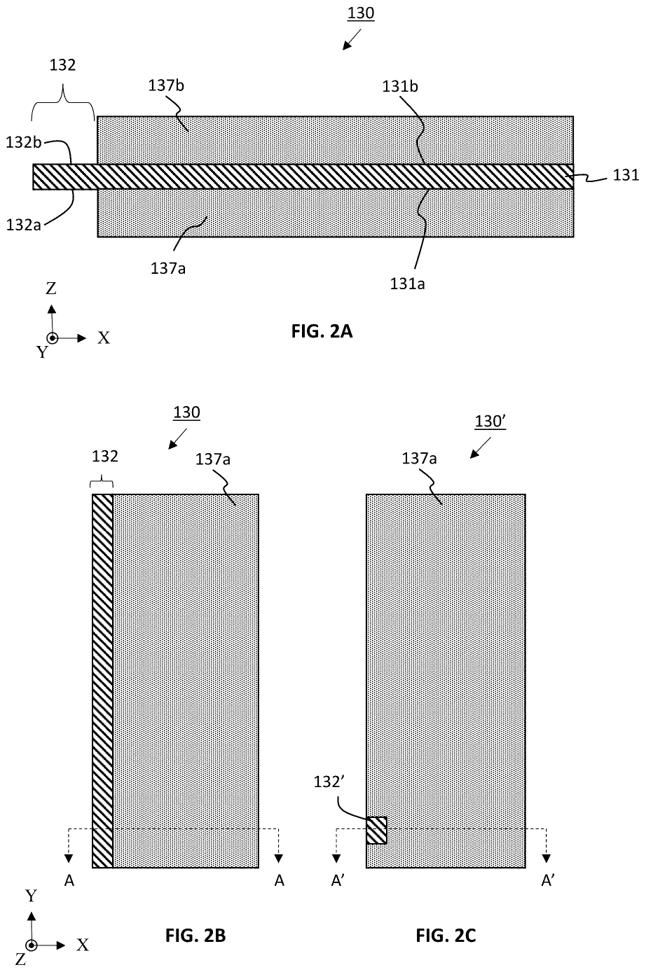

FIG. 2A is a cross-sectional view of a non-limiting example of a cathode according to some embodiments. Cathode 130 includes a cathode current collector 131. A first cathode active material layer 137a is provided on a first side 131a of the cathode current collector. A second cathode active material layer 137b is provided on a second side 131b of the cathode current collector. The cathode current collector may include an electrical contact area 132 that is free of cathode active material, e.g., where cathode active material has been removed or deposition has been prevented. As shown, cathode contact area 132 may include contact area 132a on the first side of the cathode current collector and contact area 132b on the second side of the cathode current collector. In some other embodiments, only one side is free of cathode active material. As discussed elsewhere, the contact area may engage directly with a battery terminal element, or alternatively, may represent a region to which a tab element (not shown) may be bonded, and the tab element engages with the battery terminal element.

FIG. 2B is a plan view of cathode 130 where cutline A-A may represent the cross-section of FIG. 2A. As shown, the contact area 132 may correspond to an edge area of the cathode current collector extending along the length of the cathode (Y-axis). In some embodiments (not illustrated), the contact area may extend along the short side of the cathode (X-axis), typically in conjunction with the use of tab elements. FIG. 2C is a plan view of cathode 130′ where cutline A′-A′ may correspond to the cross-section of FIG. 2A. Cathode 130′ may be similar to cathode 130 except that the contact area 132′ is confined to a localized edge area of the anode current collector, not along the entire length. Such a configuration may typically be used in conjunction with a tab element.

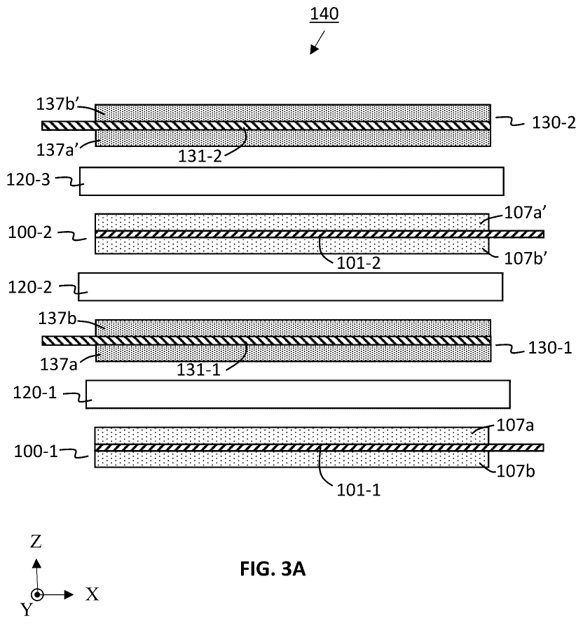

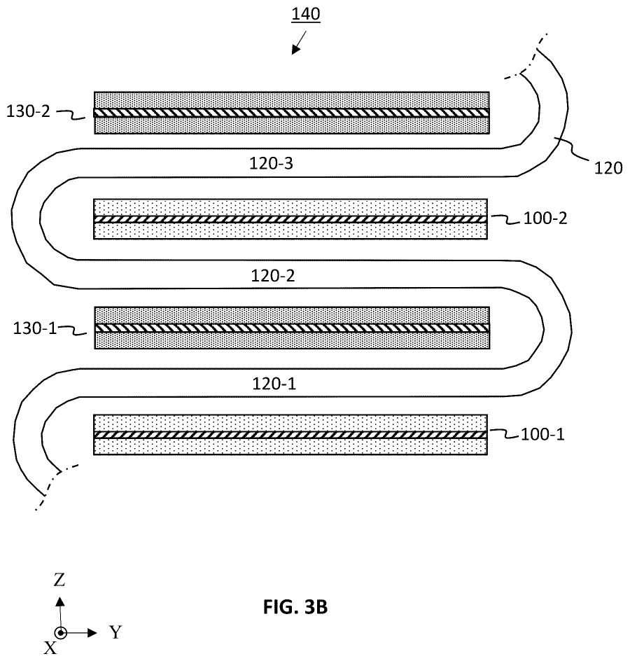

FIG. 3A is a cross-sectional view of a non-limiting example of a multilayer electrode assembly according to some embodiments. In cross section, electrode assembly 140 may include a first anode 100-1, a second anode 100-2, a first cathode 130-1 and a second cathode 130-2. The anodes and cathodes may be as described above with respect to FIGS. 1 and 2, but for clarity, not all of the elements are labelled. A first separator 120-1 may be provided between the first anode active material layer 107a of first anode 100-1 (provided on one side of first anode current collector 101-1) and the first cathode active material layer 137a of first cathode 130-1 (provided on one side of first cathode current collector 131-1) In some embodiments, a second separator 120-2 may be provided between the second cathode active material layer 137b of first cathode 130-1 (provided on the other side of first cathode current collector 131-1) and the second anode active material layer 107b′ of second anode 100-2 (provided on one side of second anode current collector 101-2) In some cases, a third separator 120-3 may be provided between the first anode active material layer 107a′ of second anode 100-2 (provided on the other side of second anode current collector 101-2) and first cathode active material layer 137a′ of second cathode 130-2 (provided on one side of second cathode current collector 131-2).

The cross section of FIG. 3A may represent a portion of a multilayer electrode assembly as may be provided in pouch cell, a prismatic cell, a cylindrical cell, or some other cell format. In some cases, the electrode assembly may have a wound or jellyroll structure wherein each anode/cathode of FIG. 3A is simply a view of the same anode/cathode at different positions in the jellyroll/wound structure. For example, in a wound structure, first anode 100-1 and second anode 100-2 are structurally part the same (continuous) anode formed using a common current collector, just at different positions in the wind when viewed in cross section.

In some other embodiments, and in reference again to FIG. 3A, the electrode assembly may include individual sheets assembled together in a stack (a stacked structure), e.g., as in a pouch cell. For example, anode 100-1 and 100-2 may be formed using separate current collectors 101-1 and 101-2, respectively, with separate active material layer formed thereon. Although the anodes may be separately stacked, the anode sheets, and in particular, their current collectors, are typically in common electrical communication with each other. The same applies for cathodes in a stacked structure. In some cases, the anodes and cathodes may be in the form of separate sheets and provided between folds of a single (continuous) separator. For example, FIG. 3B shows a rotated view from FIG. 3A where the separator 120 is folded around the anodes and cathodes (i.e., folded along the Y-axis edge) to form separators 120-1, -2, and -3, e.g., as in a pouch cell. Although not illustrated here, the separator may instead be folded along the X-axis edge so long as the folds do not interfere with contact areas.

Whether the battery assembly has a stacked structure or a jellyroll structure, in a cross-sectional view such as in FIG. 3A, the anode, first separator, cathode, and second separator may define a subunit of the battery assembly that may repeat. The battery assembly cross-section may in some cases include just the one subunit, but in some embodiments, may have a plurality of subunits. For example, a battery assembly when viewed in cross section may include 2-5 subunits, 5-10 subunits, 10-15 subunits, 15-20 subunits, 20-30 subunits, 30-40 subunits, 4-50 subunits, or any combination of ranges thereof, or even more than 50 subunits. In some cases, the battery assembly may include a partial subunit at either end. For example, an end may be an anode or cathode.

### Cylindrical Cell

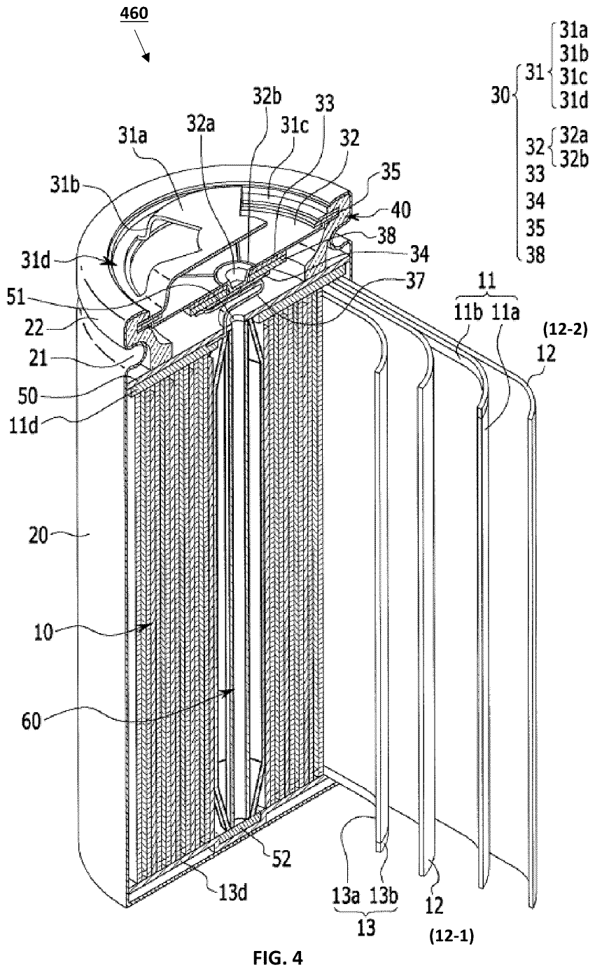

FIG. 4 is a non-limiting example of a cylindrical battery cell according to some embodiments. Cylindrical battery cell 460 may be similar to that described in U.S. Patent Application Publication No. 2023/0006189, the entire contents of which are incorporated by reference herein for all uses. The battery includes a housing that may include a cylindrical casing 20, an insulating gasket 40 and a top cap assembly 30 coupled to an opening in casing 20 with the gasket interposed therebetween. The housing is configured to accommodate electrode assembly 10, therein. Casing 20 may be in the form of a can and include a base positioned opposite the top cap. In some embodiments, a central element (e.g., a center pin) 60 is disposed at a center of electrode assembly 10. The electrode assembly 10 includes a cathode (positive electrode) 11, a separator 12 (which may include first and second separators 12-1 and 12-2 respectively), and an anode (negative electrode) 13 which are sequentially stacked. Separator 12 is disposed between the cathode 11 and the anode 13 to insulate them from each other. The electrode assembly 10 may be a cylindrical jelly-roll type formed by stacking the cathode 11, the separators 12, and the anode 13 and spirally winding them around the central element 60. Cathodes, anodes and separators are discussed in more detail elsewhere herein.

The cathode 11 and the anode 13 respectively include cathode and anode active material layer regions or areas 11a and 13a, and uncoated edge regions (i.e., contact areas) 11b and 13b without the active material thereon where bare current collector is present. The uncoated edge region 11b of the cathode and the uncoated edge region 13b of the anode may be disposed at opposite end portions of the electrode assembly 10.

When provided in the jelly-roll state inside the battery housing, a positive current collector plate 11d (a battery terminal element) may be connected to the uncoated edge region 11b of the cathode of the electrode assembly 10, and a negative current collector plate 13d (a battery terminal element) may be connected to the uncoated edge region 13b of the anode of the electrode assembly 10. The positive current collector plate 11d may be formed to be narrower than the negative current collector plate 13d so that the negative current collector plate 13d is in contact with the casing 20 while the positive current collector plate 11d is spaced apart from the casing 20 to not be in contact therewith. An insulating material may be provided at an edge area of the positive current collector plate.

In some embodiments, a lead tab 37 (a battery terminal element) may be electrically connected to the positive current collector plate 11d. One end of the lead tab 37 may be welded to the positive current collector plate 11d and the other end may be electrically connected to the top cap assembly 30. The lead tabs 37 may be bent to face one surface of the electrode assembly 10 in order to increase a contact area with the top cap assembly 30.

An insulating plate 50 having an opening exposing the central element 60 may be disposed on the positive current collector plate 11d. The insulating plate 50 may be formed to be larger than the positive current collector plate 11d so as to contact an inner surface of the casing 20. When the insulating plate 50 is formed to be larger than the positive current collector plate 11d as described above, a certain gap is formed between the positive current collector plate 11d and the casing 20 by a width of protrusion of the insulating plate 50 out of the positive current collector plate 11d. The gap between the positive current collector plate 11d and the casing 20 may serve to prevent a phenomenon in which the positive current collector plate 11d and the casing 20 come into contact with each other to form a short circuit. The lead tab 37 may be connected to a first auxiliary plate 34 of the electrode assembly 10 through an opening 51 of the insulating plate 50.

Since the electrode assembly 10 is wound around the central element 60, the central element 60 may be positioned at the approximate center of the electrode assembly 10 to be aligned with a direction in which the electrode assembly 10 is inserted into the casing 20. In some embodiments, the central element 60 may be formed of a material having certain rigidity, e.g., a metal, so as to be minimally deformed against an external impact or internal pressures. In some cases, the central element may be formed of a material having less rigidity than metal such as a polymer or foam. In some cases, the central element may be compressible when subjected to internal pressures. In some cases (not shown), the cell may include a compressible liner between the central element and the electrode assembly.

When the central element 60 is formed of a metal having conductivity, opposite ends of the central element 60 are installed to be electrically insulated from the positive current collector plate 11d and the negative current collector plate 13d. For example, an insulating pad 52 may be disposed between a lower end of the central element 60 and the negative current collector plate 13d corresponding thereto. An upper end of the central element 60 extends through a through hole formed at the center of the positive current collector plate 11d in an insulated state and is supported by the insulating plate 50. In this case, the upper end of the central element 60 may be spaced apart from the through hole of the positive current collector plate 11d, or an insulating member (not illustrated) may be interposed therebetween. Accordingly, the movement of the central element 60 in the longitudinal direction of the center pin 60 is limited, and the central element 60 may be maintained in a stable state at the center of the electrode assembly 10.

Casing 20 may have an open side into which the electrode assembly 10 is inserted, and may be formed to have substantially a same shape, e.g., a cylindrical shape, as the electrode assembly 10. Casing 20 may be connected to the negative current collecting plate 13d of the electrode assembly to serve as a negative terminal of the rechargeable battery. In some embodiments, casing 20 may be formed of a rigid material such as a conductive metal including, but not limited to, aluminum, an aluminum alloy, or nickel-plated steel.

The top cap assembly 30 is disposed at the opening of the casing 20 and is coupled to the casing 20 with a gasket 40 therebetween. Gasket 40 insulates the casing 20 from the cap assembly 30, and seals the inside of the casing 20 accommodating the electrode assembly 10 and the electrolyte solution (if not using a solid state electrolyte). In some cases, the cap assembly 30 includes a cap plate 31, a positive temperature coefficient element 35, a vent plate 32, an insulation member 33, a first auxiliary plate 34, and a second auxiliary plate 38. The first auxiliary plate 34 may be electrically connected to the lead tab 37 of the electrode assembly and may be coupled to the lead tab 37 by welding. The second auxiliary plate 38 may be stacked on the first auxiliary plate 34 to be electrically connected to the first auxiliary plate 34 and may be coupled to the first auxiliary plate 34 by welding. The second auxiliary plate 38 may be disposed at the center of the electrode assembly 10 corresponding to the central element 60 to have a through hole exposing the first auxiliary plate 34.

A vent plate 32 may be disposed above the second auxiliary plate 38 with the insulation member 33 therebetween. An edge of the vent plate 32 may be inserted into the gasket 40 to be coupled to the casing 20. The vent plate 32 may include a vent 32a disposed at a portion corresponding to the central element 60. The vent 32a protrudes from the vent plate 32 toward the electrode assembly 10 and is electrically connected to the first auxiliary plate 34 by being in contact therewith through the through hole. The vent plate 32 may have a notch 32b around the vent 32a to guide breakage of the vent 32a. The vent 32a may cut off the electrical connection with the first auxiliary plate 34 by being broken under a predetermined pressure condition to release an internal gas to the outside. That is, if the internal pressure of the casing 20 rises due to the generation of the gas, the notch 32b may be broken beforehand to allow the gas to be discharged to the outside through an exhaust port 31d, thereby preventing the rechargeable battery from exploding. In addition, if the vent 32a is broken due to an abnormal reaction, the electrical connection between the vent plate 32 and the first auxiliary plate 34 is broken. Accordingly, the electrical connection between the cap plate 31 electrically connected to the vent plate 32 and the first auxiliary plate 34 is broken, and thus no more current flows.

The cap plate 31 may include a center plate 31a corresponding to the central element 60 which is at the center of the electrode assembly 10, a plurality of branch portions 316 extending from the center plate 31a toward the insulating gasket 40, and a coupling plate 31c inserted and coupled into the insulating gasket 40 to connect ends of the branch portions 31b. The exhaust port 31d may be formed between adjacent branch portions 31b, which are opened to the outside.

The branch 31b is connected to the center plate 31a in a bent state from the coupling plate 31c so that a center of the cap plate 31 can protrude to the outside of the casing 20. The cap plate 31 may be electrically connected to the positive collector plate 11d through the vent plate 32, the second auxiliary plate 38, the first auxiliary plate 34, and the lead tab 37, so as to be used as a positive terminal of the rechargeable battery. Therefore, the connection with a terminal of an external device may be facilitated by forming the center of the cap plate 31 to protrude to the outside of the casing 20.

In some embodiments, a PTC (positive temperature coefficient) element may be formed along a second plate of the cap plate 31 and may be inserted and coupled into the gasket 40 while being stacked between the second plate of the cap plate and an edge of the vent plate. The positive temperature element 35 may be installed between the cap plate 31 and the vent plate 32 to control a current flow between the cap plate 31 and the vent plate 32 depending on an internal temperature of the rechargeable battery. When the internal temperature is within a predetermined range, the positive temperature element 35 acts as a conductor to electrically connect the cap plate 31 and the vent plate 32. If the internal temperature exceeds the predetermined temperature, the positive temperature element 35 has electrical resistance that significantly increases. As a result, the positive temperature element 35 may block the flow of a charged or discharged current between the cap plate 31 and the vent plate 32.

The edge of the cap assembly 30 may be inserted into the opening of the casing 20 after being inserted into the insulating gasket 40 in a form where the vent plate 32, the positive temperature element 35, and the cap plate 31 are stacked. Then, the cap assembly 30 is clamped to the opening of the casing 20 through a clamping process. In this case, a beading portion 21 that is recessed in a radial central direction of the casing 20 and a clamping portion 22 that clamps an outer circumference of the insulating gasket 40 into which the cap assembly 30 is inserted may be formed on the casing 20.

Although not illustrated, battery cell 460 may in some cases further include a compressible liner disposed between the cylindrical casing 20 and battery assembly 10. The top cap and/or casing may further include one or more ports for the addition or removal of electrolyte. Battery cell 460 is just one non-limiting example and there are many options available. In some cases, the battery may use so-called tabless technology where the edge contact area of the current collector includes cuts that allow it to be bent over to contact each other and an end of the battery cell, optionally with welding.

In some embodiments, the cylindrical cell format may be a so-called 18650, 21700, a 4680. In some cases, a cylindrical cell casing may have a wall thickness in a range of 0.2-0.3 mm, 0.3-0.4 mm, 0.4-0.5 mm, 0.5-0.7 mm, 0.7-0.9 mm, 0.9-1.1 mm, 1.1-1.3 mm, 1.3-1.5 mm, or any combination of ranges thereof. For example, the wall thickness of a steel (e.g., nickel-plated steel) may be in a range of 0.2-0.5 mm. In another example, the wall thickness of an aluminum or aluminum alloy casing wall may be in a range of 0.4-0.9 mm. Higher thicknesses provide more resistance to cell expansion, but add weight and cell volume (which decreases the energy density of the battery cell). Some of the embodiments of the present disclosure may allow reduction in casing wall thickness and weight or volume or both.

### Prismatic Cell

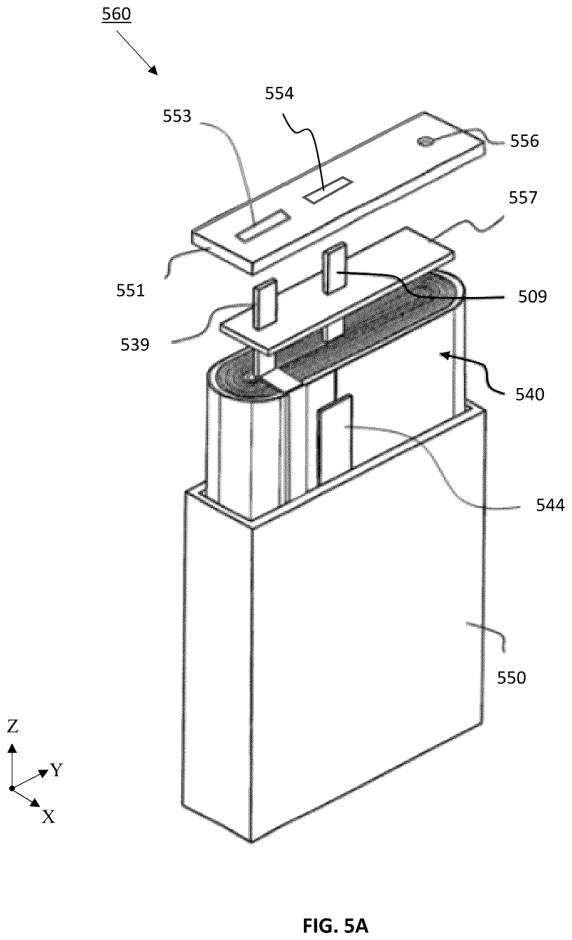

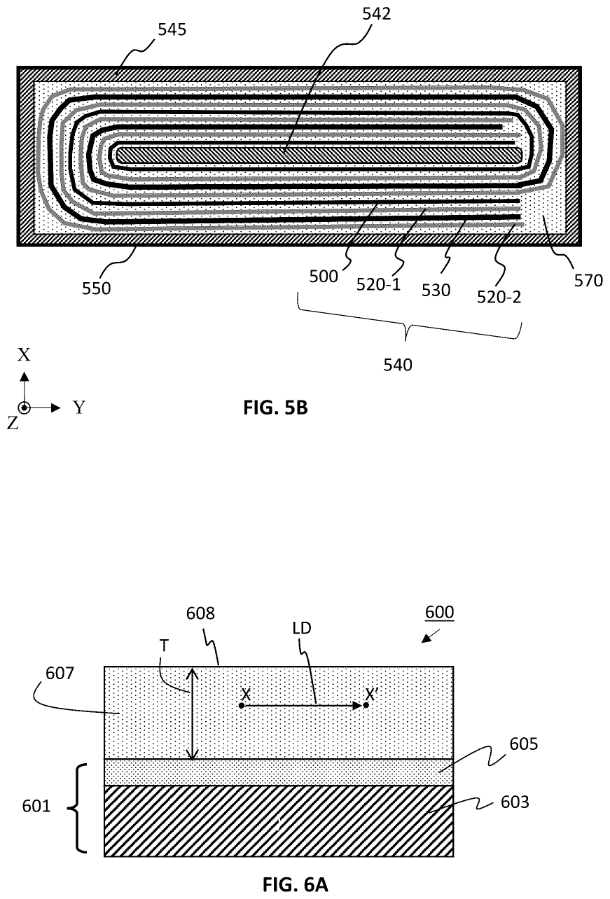

In some embodiments, a jelly-roll type structure may be used with battery cell architecture other than cylindrical cell, e.g., it may be used in a prismatic cell. FIG. 5A is a perspective, expanded view of non-limiting example of a prismatic cell according to some embodiments. FIG. 5B is a simplified cross-sectional schematic of the prismatic cell cut along the X-Y plane of a prism cell like that of FIG. 5A. Prismatic battery cell 560 may include casing 550 which may be in the form of a rectangular box. The casing may be made of a rigid material, e.g., a metal such as steel or aluminum. A jelly-roll type battery assembly 540 is provided in the casing 550. Battery assembly 540 may include anode 500, first separator 520-1, cathode 530, and second separator 520-1 wound around an elongated central element 542. The central element may be rigid or compressible. The battery cell may include anode tab 509 and cathode tab 539 for making external connection to the cell. An insulating plate or gasket 557 may be disposed between the upper portion of the battery assembly and a top lid 551. In some case, the top lid may be electrically insulating. In some cases, it may be formed from a conductive metal, but at least one, or alternatively both, of the anode and cathode tabs are insulated from the top lid. The cathode and anode tabs may extend through the insulating plate and openings 553 and 554, respectively, of a top lid 551. An insulating adhesive or other material may optionally be applied at the openings. The top lid 551 may be welded, glued, crimped, or otherwise fastened to casing 550. Top lid 551 may further include a port 556 which may be used as an electrolyte injection port, an electrolyte removal port, or both. Although not shown, additional ports may be provided. The battery cell 560 may further include a compressible liner 545 disposed between the electrode assembly 540 and the casing 550. Within the cell is also a nonaqueous lithium-ion electrolyte 570. Fastener 544 may aid in providing stability to various components battery assembly 540.

In some embodiments, a prismatic cell casing may have a wall thickness in a range of 0.2-0.3 mm, 0.3-0.4 mm, 0.4-0.5 mm, 0.5-0.7 mm, 0.7-0.9 mm, 0.9-1.1 mm, 1.1-1.3 mm, 1.3-1.5 mm, or any combination of ranges thereof. For example, the wall thickness of an aluminum or aluminum alloy casing wall may be in a range of 0.4-1.5 mm. Higher thicknesses provide more resistance to cell expansion, but add weight and cell volume (which decreases the energy density of the battery cell). Some of the embodiments of the present disclosure may allow reduction in casing wall thickness and weight or volume or both. Whether a cylindrical cell or prismatic cell, in some embodiments, a jellyroll may in some cases be wound to less than maximum tightness so that the total space between the separator and adjacent electrodes constitutes a volume relative to the overall volume of the wound electrode assembly in a range of 0.1%-0.5%, 0.5-1%, 1-2%, 2-3%, 3-5%, 5-7%, 7-10%, or any combination of ranges thereof.

### Anode

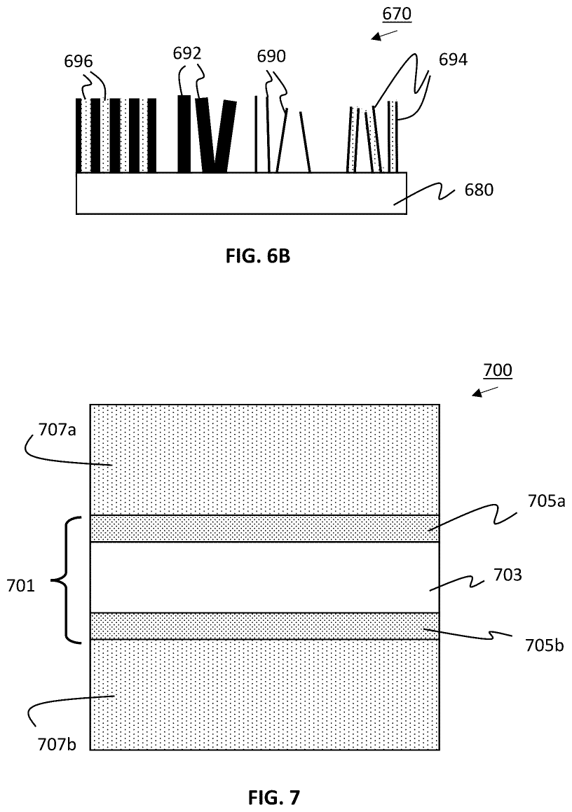

FIG. 6A is a cross-sectional schematic of an anode according to some embodiments. For clarity, just one silicon-containing anode active material layers is illustrated. Anode 600 includes current collector 601 and a silicon-containing anode active material layer 607 overlaying the current collector. For convenience, the anode active material layer 607 may sometimes be referred to herein as a lithium storage layer. In some embodiments, at least one lithium storage layer may be a silicon-containing anode active material layer deposited by a physical vapor deposition (PVD) process, e.g., by sputtering or e-beam, or by a chemical vapor deposition (CVD) process including, but not limited to, hot-wire CVD or a plasma-enhanced chemical vapor deposition (PECVD). In some embodiments, the silicon-containing anode active material layer may be a continuous porous lithium storage later as described elsewhere herein. In some embodiments the silicon-containing anode active material layer 607 includes at least 85 atomic % silicon. Current collector 601 may include a surface layer 605 provided over an electrically conductive layer 603, for example an electrically conductive metal layer. Although the figure shows the surface of the current collector as flat for convenience, the current collector may have a rough surface as discussed below. The silicon-containing anode active material layer 607 may be provided over surface layer 605. In some embodiments, the top of the silicon-containing anode active material layer 607 corresponds to a top surface 608 of anode 600. In some embodiments the silicon-containing anode active material layer 607 is in physical contact with the surface layer 605.

In some embodiments, the silicon-containing anode active material layer 607, such as a continuous porous lithium storage layer, may be substantially free of high aspect ratio nanostructures, e.g., in the form of spaced-apart wires, pillars, tubes or the like, or in the form of regular, linear vertical channels extending through the lithium storage layer. FIG. 6B shows a cross-sectional view of an anode 670 that includes some non-limiting examples of lithium storage nanostructures, such as nanowires 690, nanopillars 692, nanotubes 694 and nanochannels 696 provided over a current collector 680. While some lithium storage layers of the present disclosure may include such nanostructures, a continuous porous lithium storage layer generally does not. Unless noted otherwise, the term “lithium storage nanostructure” herein generally refers to a lithium storage active material structure (for example, a structure of silicon, germanium or their alloys) having at least one cross-sectional dimension that is less than about 2,000 nm, other than a dimension approximately normal to an underlying substrate (such as a layer thickness) and excluding dimensions caused by random pores and channels. Similarly, the terms “nanowires”, “nanopillars” and “nanotubes” refers to wires, pillars and tubes, respectively, at least a portion of which, have a diameter of less than 2,000 nm. “High aspect ratio” nanostructures have an aspect ratio greater than 4:1, where the aspect ratio is generally the height or length of a feature (which may be measured along a feature axis aligned at an angle of 45 to 90 degrees relative to the underlying current collector surface) divided by the width of the feature (which may be measured generally orthogonal to the feature axis). In some embodiments, the lithium storage layer, e.g., a continuous porous lithium storage layer, is considered “substantially free” of lithium storage nanostructures when the anode has an average (e.g., mean, median, or mode) of fewer than 10 lithium storage nanostructures per 1600 square micrometers (in which the number of lithium storage nanostructures is the sum of the number of nanowires, nanopillars, and nanotubes in the same unit area), such lithium storage nanostructures having an aspect ratio of 4:1 or higher. Alternatively, there is an average of fewer than 1 such lithium storage nanostructures per 1600 square micrometers. As noted below, the current collector may have a high surface roughness or include nanostructures, but these features are separate from the lithium storage layer and different than lithium storage nanostructures.

In some embodiments, deposition conditions are selected in combination with the current collector so that the lithium storage layer, e.g., a continuous porous lithium storage layer, is relatively smooth providing an anode with diffuse or total reflectance of at least 10% at 550 nm, alternatively at least 20% (measured at the continuous porous lithium storage layer side). In some embodiments, anodes having such diffuse or total reflectance may be less prone to damage from physical handling. In some embodiments, anodes that are not substantially free of lithium storage nanostructure may have lower reflectance and may be more prone to damage from physical handling.

Anodes of the present disclosure generally have anode active material coated on both sides. For example, FIG. 7 is a cross-sectional view of a two-sided anode according to some embodiments. The current collector 701 may include electrically conductive layer 703 and may also include surface layers (705a, 705b) provided on either side of the electrically conductive layer 703. Silicon-containing anode active material layers (707a, 707b) are disposed on both sides to form anode 700. In some embodiments, at least one of the silicon-containing anode active material layer is deposited by a PVD or CVD process. Surface layers 705a and 705b (if present) may be the same or different with respect to composition, thickness, roughness or some other property. Similarly, silicon-containing anode active material layers 707a and 707b may be the same or different with respect to composition, thickness, porosity or some other property. In some embodiments one silicon-containing anode active material layer is deposited by a slurry coating method. In some cases, both silicon-containing anode active material layers are deposited by a PVD or CVD process.

### Current Collector

In some embodiments, the current collector or the electrically conductive layer may be characterized by a tensile strength Rm or a yield strength Re. In some cases, the tensile and yield strength properties of the current collector are dependent primarily on the electrically conductive layer, which in some embodiments, may be thicker than the surface layer. If the tensile strength is too high or too low, it may be difficult to handle in manufacturing such as in roll-to-roll processes. During electrochemical cycling of the anode and the corresponding expansion/contraction of the silicon-containing anode active material, deformation of the anode may occur if the tensile strength is too low.

In some cases, the current collector or electrically conductive layer may be characterized by a tensile strength Rₘ in a range of 100-150 MPa, alternatively 150-200 MPa, alternatively 200-250 MPa, alternatively 250-300 MPa, alternatively 300-350 MPa, alternatively 350-400 MPa, alternatively 400-500 MPa, alternatively 500-600 MPa, alternatively 600-700 MPa, alternatively 700-800 MPa, alternatively 800-900 MPa, alternatively 900-1000 MPa, alternatively 1000-1200 MPa, alternatively 1200-1500 MPa, or any combination of ranges thereof. In some embodiments, the current collector or electrically conductive layer may have average thickness in a range of 4-8 μm, alternatively 8-10 μm, alternatively 10-15 μm, alternatively 10-15 μm, alternatively 15-20 μm, alternatively 20-25 μm, alternatively 25-30 μm, alternatively 30-40 μm, alternatively 40-50 μm, or any combination of ranges thereof.

In some embodiments the electrically conductive layer may have a conductivity of at least 10³ S/m, or alternatively at least 10⁶ S/m, or alternatively at least 10⁷ S/m, and may include inorganic or organic conductive materials or a combination thereof. In some embodiments, the electrically conductive layer includes a metallic material, e.g., titanium (and its alloys), nickel (and its alloys), copper (and its alloys), or stainless steel. In some embodiments, the electrically conductive layer may include a multilayer structure, e.g., include multiple layers of metal. In some embodiments, the electrically conductive layer may be a clad foil. In some embodiments, the electrically conductive layer may include an electrically conductive carbon, such as carbon black, carbon nanotubes, graphene, graphene oxide, reduced graphene oxide, and graphite.

In some embodiments the electrically conductive layer may be in the form of a foil, a mesh, a fiber, or sheet of conductive material. Herein, a conductive “mesh” includes any electrically conductive structure having openings such as found in interwoven wires, carbon nanotubes, foam structures, foils with an array of holes, or the like. In some embodiments, the electrically conductive layer may include multiple layers of different electrically conductive materials. The electrically conductive layer may be in the form of a layer deposited onto an insulating substrate (e.g., a polymer sheet or ceramic substrate coated with a conductive material, including but not limited to, nickel or copper, optionally on both sides). In some embodiments, the electrically conductive layer includes a mesh or sheet of electrically conductive carbon, including but not limited to, those formed from bundled carbon nanotubes or nanofibers, or carbon fiber.

When higher tensile strength is desirable, the electrically conductive layer may include nickel (and certain alloys), titanium (and certain alloys), or certain copper alloys, such as brass (an alloy primarily of copper and zinc), bronze (an alloy primarily of copper and tin), CuMgAgP (an alloy primarily of copper, magnesium, silver, and phosphorous), CuFe2P (an alloy primarily of copper, iron, and phosphorous) CuNi3Si (an alloy primarily of copper, nickel, and silicon). The nomenclature for the metal alloys is not the stoichiometric molecular formula used in chemistry but rather the nomenclature used by those of ordinary skill in the alloy arts. For example, CuNi3Si does not mean there are three atoms of nickel and one atom of silicon for each atom of copper. In some embodiments these nickel- or copper-based higher tensile electrically conductive layers may include roll-formed nickel or copper alloy foils.

Alternatively, a mesh or sheet of electrically conductive carbon, including but not limited to, those formed from bundled carbon nanotubes or nanofibers, may provide higher tensile strength electrically conductive layers. In some cases, electrically conductive carbon sheets or mesh may be compressible or deformable to mitigate expansion of silicon during charging. In some embodiments, an electrically conductive metal interlayer may be interposed between the electrically conductive carbon and a surface layer.

In some embodiments, the anode current collector may have a compressible structure as discussed elsewhere herein.

In some embodiments, the current collector may be characterized as having a surface roughness. In some embodiments, and referring again to FIG. 6A, the top surface 608 of the silicon-containing anode active material layer 607 may have a lower surface roughness than the surface roughness of current collector 601. Herein, surface roughness comparisons and measurements may be made using the Roughness Average (Rₐ), RMS Roughness (R_{q}), Maximum Profile Peak Height roughness (Rₚ), Average Maximum Height of the Profile (R_{z}), or Peak Density (P_{c}). In some embodiments, the current collector may be characterized as having both a surface roughness R_{z}≥2.5 μm and a surface roughness Rₐ≥0.25 μm. In some embodiments, R_{z} is in a range of 2.5-3.0 μm, alternatively 3.0-3.5 μm, alternatively 3.5-4.0 μm, alternatively 4.0-4.5 μm, alternatively 4.5-5.0 μm, alternatively 5.0-5.5 μm, alternatively 5.5-6.0 μm, alternatively 6.0-6.5 μm, alternatively 6.5-7.0 μm, alternatively 7.0-8.0 μm, alternatively 8.0-9.0 μm, alternatively 9.0 to 10 μm, 10 to 12 μm, 12 to 14 μm or any combination of ranges thereof. In some embodiments, Rₐ is in a range of 0.25-0.30 μm, alternatively 0.30-0.35 μm, alternatively 0.35-0.40 μm, alternatively 0.40-0.45 μm, alternatively 0.45-0.50 μm, alternatively 0.50-0.55 μm, alternatively 0.55-0.60 μm, alternatively 0.60-0.65 μm, alternatively 0.65-0.70 μm, alternatively 0.70-0.80 μm, alternatively 0.80-0.90 μm, alternatively 0.90-1.0 μm, alternatively 1.0-1.2 μm, alternatively 1.2-1.4 μm, or any combination of ranges thereof.

In some embodiments, some or most of the surface roughness of the current collector may be imparted by the electrically conductive layer. Alternatively, some or most of the surface roughness of the current collector may be imparted by the surface layer. Alternatively, some combination of the electrically conductive layer, metal interlayer, and surface layer may contribute substantially to the surface roughness. In some embodiments, the electrically conductive layer may include roughening features, e.g., electrodeposited roughening features, to increase surface roughness. Alternatively, or in combination with the electrodeposited roughening features, the electrically conductive layer may undergo another electrochemical, chemical, chemical, or physical treatment to impart a desired surface roughness prior to formation of the surface layer (if used). In some embodiments, roughening of the electrically conductive layer may include, for example, physical abrasion (such as sandpaper, sand blasting, polishing, or the like), ablation (such as by laser ablation), embossing, stamping, casting, imprinting, chemical treatments, electrochemical treatments, or thermal treatments. In some cases, roughening features may be random, or alternatively, may have a predetermined pattern.

### Surface Layer

In some embodiments, a surface layer may provide a chemical composition that promotes formation of an adherent silicon-containing anode active material layer, particularly at commercially useful loadings or thicknesses of the anode active layer. In some cases, deposition onto an electrically conductive layer alone may be insufficient to provide even initial adhesion such that the anode active material readily brushes or peels off. Even when there is satisfactory initial adherence, it may be insufficient during electrochemical formation and cycling. Some non-limiting examples of surface layers are discussed below. In some cases, a surface layer may include two or more distinct surface sublayers having different chemical compositions. In some cases, a surface layer or even a surface sublayer may include a mixture of different surface layer materials.

The thickness of a surface layer may be as low as a monolayer in some embodiments. In some embodiments, the thickness of the surface layer is in a range of 0.0001 μm to 0.0002 μm, alternatively 0.0002 μm to 0.0005 μm, alternatively 0.0005 μm to 0.001 μm, alternatively 0.001 μm to 0.005 μm, alternatively 0.002 μm to 0.005 μm, alternatively, 0.005 μm to 0.01 μm, alternatively 0.01 μm to 0.02 μm, alternatively 0.02 μm to 0.03 μm, alternatively 0.03 μm to 0.05 μm, alternatively 0.05 μm to 0.1 μm, alternatively 0.1 μm to 0.2 μm, alternatively 0.2 μm to 0.5 μm, alternatively 0.5 μm to 1 μm, alternatively 1 μm to 2 μm, alternatively 2 μm to 5 μm or any combination of ranges thereof.

In some embodiments, the surface layer or sublayer may include a metal-oxygen compound. In some cases, a metal-oxygen compound may include a metal oxide or metal hydroxide, e.g., a transition metal oxide or a transition metal hydroxide. In some cases, a metal-oxygen compound may include an oxometallate, e.g., a transition oxometallate. In some embodiments, a surface layer may include a silicon compound including or derived from a siloxane, a silane (i.e., a silane-containing compound), a silazane, or a reaction product thereof. Herein, a “silicon compound” does not include simple elemental silicon such as amorphous silicon. In some embodiments, a surface layer may include a silicate compound. In some embodiments, a surface layer may include a metal silicide, e.g., a transition metal silicide. In some embodiments, a surface layer may include a metal chalcogenide such as a metal sulfide, e.g., a transition metal sulfide.

### Metal-Oxygen Compounds

In some embodiments, the surface layer or a surface sublayer includes a metal-oxygen compound. The metal-oxygen compound may include an alkali metal, an alkaline earth metal, a transition metal, or a post transition metal. Unless otherwise noted, the term “transition metal” as used anywhere in the present application includes any element in groups 3 through 12 of the periodic table, including lanthanides and actinides. Metal-oxygen compounds may include metal oxides, metal hydroxides, oxometallates, or a mixture thereof. In some cases, the metal-oxygen compound may include a transition metal oxide, a transition metal hydroxide, a transition metal oxometallate, or a mixture thereof. In some embodiments, a metal interlayer may be provided between the electrically conductive layer and a surface layer that includes metal-oxygen compound. In some embodiments, the metal interlayer may be a transition metal. In some cases, the metal interlayer may include zinc, nickel, or an alloy of zinc and nickel. The interlayer may be considered part of the electrically conductive layer such that the metal interlayer is interposed between the surface layer and the rest of the underlying electrically conductive layer.

### Metal Oxides

In some embodiments, a surface layer or surface sublayer may include a metal oxide. In some embodiments, the metal oxide may include a transition metal oxide. In some embodiments, the metal oxide may include an oxide of scandium, titanium, vanadium, chromium, manganese, iron, cobalt, nickel, copper, yttrium, zinc, molybdenum, tungsten, silver, zirconium, tantalum, hafnium, tin, aluminum, indium, or niobium. In some embodiments, a metal oxide may be an electrically conductive doped oxide, including but not limited to, indium-doped tin oxide (ITO) or an aluminum-doped zinc oxide (AZO). In some embodiments, the metal oxide may include an alkali metal oxide or alkaline earth metal oxide. In some embodiments the metal oxide may include an oxide of lithium. The metal oxide may include mixtures of metal oxides. For example, an “oxide of nickel” may optionally include other metal oxides in addition to nickel oxide. In some embodiments, a metal oxide includes an oxide of an alkali metal (e.g., lithium or sodium) or an alkaline earth metal (e.g., magnesium or calcium) along with an oxide of a transition metal (e.g., titanium, nickel, or copper). In some embodiments, the metal oxide may include some amount of hydroxide such that the ratio of oxygen atoms in the form of hydroxide relative to oxide is equal to or less than 1-to-1, respectively, alternatively less than 1-to-2, 1-to-3, or 1-to-4. The metal oxide may include a stoichiometric oxide, a non-stoichiometric oxide or both. In some embodiments, the metal within the metal oxide may exist in multiple oxidation states. Ordinarily, oxometallates may be considered a subclass of metal oxides. For the sake of clarity, any reference herein to “metal oxide” with respect to its use in a surface layer or sublayer excludes oxometallates unless otherwise stated.

In some embodiments, a surface layer or sublayer of metal oxide may be at least 1 monolayer in thickness, alternatively at least 2, 3, 5, or 10 monolayers. In some embodiments, a surface layer or sublayer having a metal oxide material may have an average thickness of at least 0.1 nm, alternatively at least 0.2 nm. In some embodiments, a surface layer or sublayer having a metal oxide material may have an average thickness of less than 5000 nm, alternatively less than 3000 nm. In some embodiments, a surface layer or sublayer having a metal oxide material may have an average thickness in a range of 0.1-0.2 nm, alternatively 0.2-0.5 nm, alternatively 0.5-1 nm, alternatively 1-2 nm, alternatively 2-5 nm, alternatively 5 to 10 nm, alternatively 10-20 nm, alternatively 20-50 nm, alternatively 50-100 nm, alternatively 100-200 nm, alternatively 200-500 nm, alternatively 500-1000 nm, alternatively 1000-1500 nm, alternatively 1500-2000 nm, alternatively 2000-2500 nm, alternatively 2500-3000 nm, alternatively 3000-4000 nm, alternatively 4000-5000 nm, or any combination of ranges thereof.

In some embodiments, the metal oxide may be formed by atomic layer deposition (ALD), chemical vapor deposition (CVD), thermal vapor deposition, or sputtering. In some cases, a metal oxide may be formed by coating a suspension of metal oxide particles. In some embodiments, a metal oxide may be electrolytically plated or electrolessly plated (which may include “immersion plating”).

In some embodiments, a metal oxide precursor composition may be coated or printed over a current collector having one or more surface sublayers as described above and then treated to form the metal oxide. Some non-limiting examples of metal oxide precursor compositions include sol-gels (metal alkoxides), metal carbonates, metal acetates (including organic acetates), metal hydroxides and metal oxide dispersions. The metal oxide precursor composition may be thermally treated to form the metal oxide.

In some embodiments, the metal oxide precursor composition may include a metal, e.g., metal-containing particles or a sputtered metal layer. The metal may then be oxidized in the presence of oxygen (e.g., thermally), electrolytically oxidized, chemically oxidized in an oxidizing liquid or gaseous medium or the like to form the metal oxide.

### Metal Hydroxides

In some embodiments, a surface layer or surface sublayer may include a metal hydroxide. In some embodiments, the metal hydroxide may include a transition metal hydroxide. In some embodiments, the metal hydroxide may include a hydroxide of scandium, titanium, vanadium, chromium, manganese, iron, cobalt, nickel, copper, yttrium, zinc, molybdenum, tungsten, silver, zirconium, tantalum, hafnium, tin, aluminum, indium, or niobium. In some embodiments, the metal hydroxide may include an alkali metal hydroxide or alkaline earth metal hydroxide. In some embodiments the metal hydroxide may include a hydroxide of lithium. The metal hydroxide may include mixtures of metal hydroxides. For example, a “hydroxide of nickel” may optionally include other metal hydroxides in addition to nickel hydroxide. In some embodiments, a metal hydroxide includes a hydroxide of an alkali metal (e.g., lithium or sodium) or an alkaline earth metal (e.g., magnesium or calcium) along with a hydroxide of a transition metal (e.g., titanium, nickel, or copper). In some embodiments, a metal hydroxide sublayer may include some amount of oxide such that the ratio of oxygen atoms in the form of oxide relative to hydroxide is less than 1-to-1, respectively, alternatively less than 1-to-2, 1-to-3, or 1-to-4. The metal hydroxide may include a stoichiometric hydroxide, a non-stoichiometric hydroxide or both. In some embodiments, the metal within the metal hydroxide may exist in multiple oxidation states.

In some embodiments, a surface sublayer of metal hydroxide (“metal hydroxide sublayer”) may be at least 1 monolayer in thickness, alternatively at least 2, 3, 5, or 10 monolayers. In some embodiments, a surface layer or sublayer having a metal hydroxide material may have an average thickness of at least 0.1 nm, alternatively at least 0.2 nm. In some embodiments, a surface layer or sublayer having a metal hydroxide material may have an average thickness of less than 5000 nm, alternatively less than 3000 nm. In some embodiments, a surface layer or sublayer having a metal hydroxide material may have an average thickness in a range of 0.1-0.2 nm, alternatively 0.2-0.5 nm, alternatively 0.5-1 nm, alternatively 1-2 nm, alternatively 2-5 nm, alternatively 5 to 10 nm, alternatively 10-20 nm, alternatively 20-50 nm, alternatively 50-100 nm, alternatively 100-200 nm, alternatively 200-500 nm, alternatively 500-1000 nm, alternatively 1000-1500 nm, alternatively 1500-2000 nm, alternatively 2000-2500 nm, alternatively 2500-3000 nm, alternatively 3000-4000 nm, alternatively 4000-5000 nm, or any combination of ranges thereof.

In some embodiments, the metal hydroxide may be formed by atomic layer deposition (ALD), chemical vapor deposition (CVD), thermal vapor deposition, or sputtering. In some cases, a metal hydroxide may be formed by coating a suspension of metal hydroxide particles. In some embodiments, a metal hydroxide may be electrolytically plated or electrolessly plated (which may include “immersion plating”).

In some embodiments, a metal hydroxide precursor composition may be coated or printed over a current collector having one or more surface sublayers as described above and then treated to form the metal hydroxide. Some non-limiting examples of metal hydroxide precursor compositions may include sol-gels (metal alkoxides), metal carbonates, metal acetates (including organic acetates) and metal oxide dispersions. The metal hydroxide precursor composition may be thermally treated, optionally in the presence of water or an alkaline aqueous medium to form the metal hydroxide.

In some embodiments, the metal hydroxide precursor composition may include a metal, e.g., metal-containing particles or a metal layer. The metal may then be oxidized in the presence of oxygen (e.g., thermally), electrolytically oxidized, chemically oxidized in an oxidizing liquid or gaseous medium or the like to form the metal hydroxide. Such oxidation may optionally be carried out in the presence of water or under alkaline conditions.

### Oxometallates

As noted previously, oxometallates herein are considered separately from other non-anionic metal oxides. Oxometallates may be considered a type of metal oxide where the metal oxide moiety is anionic in nature and is associated with a cation, which may optionally be an alkali metal, an alkaline earth metal, a transition metal, or even a post transition metal. In some embodiments, a transition oxometallate may include scandium, titanium, vanadium, manganese, iron, cobalt, nickel, copper, yttrium, zirconium, niobium, molybdenum, tantalum, or tungsten. In some embodiments, a transition oxometallate may include a chromate, tungstate, vanadate, or molybdate. In some embodiments, the surface layer or surface sublayer may include, or be formed from, a transition oxometallate other than chromate.

In some embodiments, an oxometallate may be formed by sputtering. In some cases, an oxometallate may be formed by coating a suspension or solution of oxometallate material or particles. In some embodiments, an oxometallate may be electrolytically plated or electrolessly plated (which may include “immersion plating”). In some embodiments, such electrolytic or electroless plating may use a solution including a transition oxometallate. In some cases, the nature of the deposited coating may include a mixture of transition metal oxide, hydroxide and/or oxometallate.

In some embodiments, the amount of a transition metal from a transition oxometallate in the surface layer or sublayer may be at least 0.5 mg/m², alternatively at least 1 mg/m², alternatively at least 2 mg/m². In some embodiments, the amount of the transition metal from a transition oxometallate is less than 250 mg/m². In some embodiments, the amount of the transition metal from a transition oxometallate may be in a range of 0.5-1 mg/m², alternatively 1-2 mg/m², alternatively 2-5 mg/m², alternatively 5-10 mg/m², alternatively 10-20 mg/m², alternatively 20-50 mg/m², alternatively 50-75 mg/m², alternatively 75-100 mg/m², alternatively 100-250 mg/m², or any combination of ranges thereof. In some embodiments, a surface layer or sublayer having an oxometallate material may be at least 0.2 nm thick, alternatively at least 0.5 nm thick, alternatively at least 1 nm thick, at least 2 nm thick. In some embodiments a surface layer or sublayer having an oxometallate material may have a thickness in a range of 0.2-0.5 nm, alternatively 0.5-1.0 nm, alternatively 1.0-2.0 nm, alternatively 2.0-5.0 nm, alternatively 5.0-10 nm, alternatively 10-20 nm, alternatively 20-50 nm, alternatively 50-100 nm, or any combination of ranges thereof.

A transition metallate generally refers to a transition metal compound bearing a negative charge. The anionic transition metal compound may be associated with one or more cations (a “transition metallate compound”), which may optionally be an alkali metal, an alkaline earth metal, ammonium, alkylammonium, another transition metal (which may be the same or different than the transition metal of the anionic transition metal compound), or some other cationic species. A transition oxometallate is a particular type of transition metallate. Besides transition oxometallates, some non-limiting examples of useful transition metallates may include sulfometallates, cyanometallates, and halometallates, which may be used singly or in combination, or in combination with oxometallates. Unless noted to the contrary, embodiments using a transition oxometallate may instead use a transition metallate.

### Silicon Compounds

In some embodiments, a surface layer or sublayer includes a silicon compound formed by treatment with a silane, a siloxane, or a silazane compound, any of which may be referred to herein as a silicon compound agent. As mentioned, a silicon compound or a silicon compound agent does not include silicate compounds. In some embodiments, the silicon compound agent treatment may increase adhesion to an overlying sublayer or to the lithium storage layer. In some embodiments, the silicon compound may be a polymer including, but not limited to, a polysiloxane. In some embodiments, a siloxane compound may have a general structure as shown in formula (1)

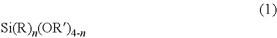

wherein, n=1, 2, or 3, and R and R′ are independently selected substituted or unsubstituted alkyl, alkenyl, or aryl groups.

The silicon compound of the layer or sublayer may be derived from a silicon compound agent but have a different chemical structure than the agent used to form it. In some embodiments, the silicon compound may react with the underlying surface to form a bond such as a metal-oxygen-silicon bond, and in doing so, the silicon compound may lose one or more functional groups (e.g., an OR′ group from a siloxane). In some embodiments, the silicon compound agent may include groups that polymerize to form a polymer. In some embodiments, the silicon compound agent may form a matrix of Si—O—Si cross links. In some embodiments, the PECVD deposition of a lithium storage material may alter the chemical structure of the silicon compound agent or even form a secondary derivative chemical species. The silicon compound includes silicon. The silicon compound may be the result of a silicon compound agent reacting with 1, 2, 3, or 4 reactants in 1, 2, 3, or 4 different reactions.

A silicon compound agent may be provided in a solution, e.g., at about 0.3 g/l to 15 g/l in water or an organic solvent. Adsorption methods of a silicon compound agent include an immersion method, a showering method and a spraying method and are not especially limited. In some embodiments a silicon compound agent may be provided as a vapor and adsorbed onto an underlying sublayer. In some embodiments, a silicon compound agent may be deposited by initiated chemical vapor deposition (iCVD). In some embodiments, a silicon compound agent may include an olefin-functional silane moiety, an epoxy-functional silane moiety, an acryl-functional silane moiety, an amino-functional silane moiety, or a mercapto-functional silane moiety, optionally in combination with siloxane or silazane groups. In some embodiments, the silicon compound agent may be a siloxysilane. In some embodiments, a silicon compound agent may undergo polymerization during deposition or after deposition. Some non-limiting examples of silicon compound agents include hexamethyldisilazane (HMDS), vinyltrimethoxysilane, vinylphenyltrimethoxysilane, 3-methacryloxypropyltrimethoxysilane, 3-glycidoxypropyltrimethoxysilane, 3-glycidoxypropyltriethoxysilane, 4-glycidylbutyltrimethoxysilane, 3-aminopropyltriethoxysilane, N-2-(aminoethyl)-3-aminopropyltrimethoxysilane, N-3-(4-(3-aminopropoxy) butoxy) propyl-3-aminopropyltrimethoxysilane, imidazolesilane, triazinesilane, 3-mercaptopropyltrimethoxysilane, 1,3,5,7-tetravinyl-1,3,5,7-tetramethylcyclotetrasiloxane, 1,3,5-trivinyl-1,3,5-trimethylcyclotrisiloxane, pentavinylpentamethylcyclopentasiloxane, and octavinyl-T8-silesquioxane. In some embodiments, a layer or sublayer including a silicon compound may include silicon, oxygen, and carbon, and may further include nitrogen or sulfur.

In some embodiments, treatment with a silicon compound agent may be followed by a step to drive off solvent or to initiate polymerization or another chemical transformation, wherein the step may involve heating, contact with a reactive reagent, or both. In some embodiments, a surface layer or sublayer formed using a silicon compound agent may have a silicon content in a range of 0.1 to 0.2 mg/m², alternatively in a range of 0.1-0.25 mg/m², alternatively in a range of 0.25-0.5 mg/m², alternatively in a range of 0.5-1 mg/m², alternatively 1-2 mg/m², alternatively 2-5 mg/m², alternatively 5-10 mg/m², alternatively 10-20 mg/m², alternatively 20-50 mg/m², alternatively 50-100 mg/m², alternatively 100-200 mg/m², alternatively 200-300 mg/m², or any combination of ranges thereof. In some embodiments, a surface layer or sublayer formed from a silicon compound agent may include up to one monolayer of the silicon compound agent or its reaction product, alternatively up to 2 monolayers; alternatively up to 4 monolayers, alternatively up to 6 monolayers, alternatively up to 8 monolayers, alternatively up to 10 monolayers, alternatively up to 15 monolayers, alternatively up to 20 monolayers, alternatively up to 50 monolayers, alternatively up to 100 monolayers, alternatively up to 200 monolayers. The surface layer or surface sublayer having the silicon compound may be porous. In some embodiments, the silicon compound may break down or partially breaks down during deposition of the lithium storage layer.

### Silicates

The surface layer may include a silicate compound. A silicate compound may include, or be formed from a solution containing, silicic acid or an anionic silicate species. Herein, an anionic silicate species is one that includes silicon and oxygen and is typically associated with an appropriate cationic moiety. In some cases, an anionic silicate species may be represented by formula (2)

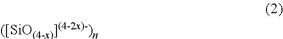

where 0≤x<2, and n ≥1. In some case, the anionic silicate species may include [SiO₄]⁴⁻ (x=0, n=1, which may in some cases be referred to as an orthosilicate), [SiO₃]²⁻ (x=1, n=1, which may in some cases be referred to as a metasilicate), or [Si₂O₇]⁶⁻ (x=0.5, n=2, which may in some cases be referred to as a pyrosilicate). Anionic silicate species may in some cases include larger structures, such as polysilicates where n≤3.

In some embodiments, the associated cationic moiety may include a proton, a metal (“a metal silicate”), an alkylammonium moiety, or a mixture thereof. A metal silicate may include an alkali metal, an alkaline earth metal, a transition metal, a post-transition metal. In some embodiments a silicon compound may include a mixture of silicic acid and a metal silicate.

In some embodiments a surface layer may be formed by contacting a current collector precursor with a silicate treatment agent. The current collector precursor generally includes the electrically conductive layer and may optionally include one or more additional surface sublayers as discussed elsewhere herein. The silicate treatment agent may include, for example, an aqueous mixture (solution, dispersion, emulsion, or the like) that includes a silicate compound. In some cases, the silicate compound may have a water solubility of at least 10 ppm, alternatively at least 50 ppm, or alternatively at least 100 ppm. In some cases, the treatment agent may include silicic acid, a sodium silicate, a potassium silicate, or a mixture thereof. In some embodiments, the aqueous mixture may have a pH of at least 2, alternatively at least 4. In some embodiments, the aqueous mixture may have a pH in a range of about 4 to 5, alternatively 5 to 6, alternatively 6 to 7, alternatively 7 to 8, alternatively 8 to 9, alternatively 9 to 10, alternatively 10 to 11, alternatively 11 to 12, or any combination of ranges thereof.

In some cases, the silicate treatment agent may be provided as a bath into which the current collector precursor is immersed, or alternatively it may be spray applied or otherwise coated onto the current collector precursor. Contact with the silicate treatment agent may optionally include agitation such as bath circulation, sparging, stirring, movement of the current collector precursor, or the like. The silicate treatment agent may be at ambient temperature, or may be controlled, for example, in a temperature range of about 0° C.-5° C., alternatively 5° C.-10° C., alternatively 10° C.-15° C., alternatively 15° C.-20° C., alternatively 20° C.-25° C., alternatively 25° C.-30° C., alternatively 30° C.-40° C., 40° C.-50° C., alternatively 50° C.-60° C., alternatively 60° C.-80° C., or any combination of ranges thereof. In some cases, contact with the silicate treatment agent may be followed by a rinse with a rinsing agent. In some embodiments, the rinsing agent may include water, such as distilled water or tap water. A rinsing agent may optionally include other materials such as surfactants, dispersants, neutralizing materials, or some other material.

In some embodiments, the areal density of silicon from the silicate compound in the surface layer may be at least 0.2 mg/m², alternatively at least 0.5 mg/m². In some embodiments, the areal density of silicon from the silicate compound in the surface layer may be in a range of 0.2-0.5 mg/m², alternatively 0.5-1.0 mg/m², alternatively 1.5-2 mg/m², alternatively 2-3 mg/m², alternatively 3-5 mg/m², alternatively 5-7 mg/m², alternatively 7-10 mg/m², alternatively 10-15 mg/m², alternatively 15-20 mg/m², alternatively 20-30 mg/m², alternatively 30-50 mg/m², or any combination of ranges thereof.

### Metal Silicides

The surface layer may include a metal silicide. In some embodiments the metal silicide may have a chemical composition characterized by MₓSi_{y}, wherein Mis a transition metal, x is the combined atomic % of one or more transition metals, y is the atomic % of silicon, and the ratio of x to y is in a range of about 0.25 to about 7. The ratio of x to y may vary within the metal silicide layer. In some embodiments, the surface layer may include metal silicide having a gradient in metal content, e.g., where the atomic % of the transition metal(s) decreases in the direction towards the lithium storage layer. When the ratio of x to y falls below 0.25, the silicon may in some embodiments be considered herein to be part of the lithium storage layer. When the ratio of x to y is above 7, the transition metal may be considered herein to be part of an electrically conductive layer. In some embodiments, M=Ti, V, Cr, Mn, Fe, Co, Ni, Cu, Zr, Mo, or W, or a binary or ternary combination thereof. The metal silicide may be stoichiometric or non-stoichiometric. The metal silicide layer may include a mixture of metal silicides having homogeneously or heterogeneously distributed stoichiometries, mixtures of metals, or both.

In some embodiments, the areal density of silicon from the metal silicide in the surface layer may be at least 0.2 mg/m², alternatively at least 0.5 mg/m². In some embodiments, the areal density of silicon from the metal silicide in the surface layer may be in a range of 0.2-0.5 mg/m², alternatively 0.5-1.0 mg/m², alternatively 1.5-2 mg/m², alternatively 2-3 mg/m², alternatively 3-5 mg/m², alternatively 5-7 mg/m², alternatively 7-10 mg/m², alternatively 10-15 mg/m², alternatively 15-20 mg/m², alternatively 20-30 mg/m², alternatively 30-50 mg/m², alternatively 50-100 mg/m², alternatively 100-200 mg/m², alternatively 200-300 mg/m², alternatively 300-400 mg/m², alternatively 400-500 mg/m², or any combination of ranges thereof.

In some embodiments, the metal silicide has an electrical conductivity of at least 102 S/m, alternatively at least 10³ S/m, alternatively at least 104 S/m, alternatively at least 105 S/m, alternatively at least 10⁶ S/m.

In some embodiments, the metal silicide may be formed prior to deposition of the silicon-containing anode active material layer. For example, the metal silicide layer may be formed directly by atomic layer deposition (ALD), PECVD, or by a PVD process such as sputtering. Sputtering may use a single metal silicide sputter source or two sources, one for the metal and the other for silicon. In some embodiments, a slurry of metal silicide particles may be coated onto an electrically conductive layer and optionally dried or sintered. In some embodiments, the metal silicide layer may be formed by heating a metal layer (e.g., a metal part of the electrically conductive layer) that is in contact with a silicon layer.

### Lithium Storage Layer (Anode Active Material Layer)

The lithium storage layer may include a silicon containing anode active material capable of reversibly incorporating lithium, e.g., as a continuous porous lithium storage layer. In addition to silicon, the anode active material may further include germanium, antimony, tin, or a mixture. In some embodiments, the silicon-containing anode active material is substantially amorphous. In some embodiments, the lithium storage layer includes substantially amorphous silicon. Such substantially amorphous storage layers may include a small amount (e.g., less than 20 atomic %) of crystalline material dispersed therein. The storage layer may include dopants such as hydrogen, boron, phosphorous, carbon, sulfur, fluorine, aluminum, gallium, indium, arsenic, antimony, bismuth, nitrogen, or metallic elements. In some embodiments the lithium storage layer may include porous substantially amorphous hydrogenated silicon (a-Si:H), having, e.g., a hydrogen content of from 0.1 to 20 atomic %, or alternatively higher. In some embodiments, the lithium storage layer may include methylated amorphous silicon. Note that, unless referring specifically to hydrogen content, any atomic % metric used herein for a lithium storage material or layer refers to atoms other than hydrogen.

In some embodiments, the silicon-containing anode active material layer, e.g., a continuous porous lithium storage layer, may include at least 40 atomic % silicon, alternatively at least 50 atomic %, alternatively at least 60 atomic %, alternatively at least 70 atomic %, alternatively at least 80 atomic %, alternatively at least 90 atomic %, alternatively at least 95 atomic %, alternatively at least 97 atomic %, alternatively at least 98 atomic %, or alternatively at least 99 atomic %. In some cases, the silicon-containing anode active material layer may include silicon in a range of 40-50 atomic %, 50-60 atomic %, 60-70 atomic %, 70-80 atomic %, 80-90 atomic %, 90-95 atomic %, 95-97 atomic %, 97-98 atomic %, or 98-99 atomic %, or any combination of ranges thereof. Note that in the case of prelithiated anodes as discussed below, the lithium content is excluded from this atomic % characterization.

In some embodiments, the silicon-containing anode active material layer, e.g., a continuous porous lithium storage layer, may include less than 10 atomic % carbon, alternatively less than 5 atomic %, alternatively less than 2 atomic %, alternatively less than 1 atomic %, alternatively less than 0.5 atomic %, alternatively less than 0.3 atomic %. In some embodiments, the silicon-containing anode active material layer may include less than 15% by total weight of carbon-based binders, graphitic carbon, graphene, graphene oxide, reduced graphene oxide, carbon black or conductive carbon, alternatively less than 10%, alternatively less than 5%, or alternatively less than 2%. In some embodiments, the silicon-containing anode active material layer may be substantially free of carbon-based binders, graphitic carbon, graphene, graphene oxide, reduced graphene oxide, carbon black and conductive carbon, i.e., the lithium storage layer includes less than 1% by total weight of such carbon materials, alternatively less than 0.5%, alternatively less than 0.3%, alternatively less than 0.1%, alternatively less than 0.01%. A few non-limiting examples of carbon-based binders may include organic polymers such as those based on styrene butadiene rubber, polyvinylidene fluoride, polytetrafluoroethylene, polyacrylic acid, carboxymethyl cellulose, or polyacrylonitrile.

The silicon-containing active anode material layer, e.g., a continuous porous lithium storage layer, may include voids or interstices (pores), which may be random or non-uniform with respect to size, shape, and distribution. With respect to a continuous porous lithium storage layer, such porosity does not result in, or result from, the formation of any recognizable lithium storage nanostructures such as nanowires, nanopillars, nanotubes, ordered nanochannels or the like. In some embodiments, the pores may be polydisperse. In some embodiments, a porous lithium storage layer may be characterized as nanoporous. In some embodiments the silicon-containing anode active material layer may have an average density in a range of 1.0-1.1 g/cm³, alternatively 1.1-1.2 g/cm³, alternatively 1.2-1.3 g/cm³, alternatively 1.3-1.4 g/cm³, alternatively 1.4-1.5 g/cm³, alternatively 1.5-1.6 g/cm³, alternatively 1.6-1.7 g/cm³, alternatively 1.7-1.8 g/cm³, alternatively 1.8-1.9 g/cm³, alternatively 1.9-2.0 g/cm³, alternatively 2.0-2.1 g/cm³, alternatively 2.1-2.2 g/cm³, alternatively 2.2-2.25 g/cm³, alternatively 2.25-2.29 g/cm³, or any combination of ranges thereof, and includes at least 70 atomic % silicon, 80 atomic % silicon, alternatively at least 85 atomic % silicon, alternatively at least 90 atomic % silicon, alternatively at least 95 atomic % silicon, alternatively at least 97 atomic % silicon, alternatively at least 98 atomic % silicon, alternatively at least 99 atomic % silicon. The foregoing may apply especially to silicon deposited by a PVD or a CVD process, but may also apply to some slurry-coated silicon dominant materials. Note that a density of less than 2.3 g/cm³ is evidence of the porous nature of a-Si containing lithium storage layers. In some embodiments, lower density/higher porosity may allow lower cell expansion during charging (e.g., from less expansion of the silicon layer during lithiation). Note also that the foregoing density ranges apply to the layer “as deposited”. In the cell, in particular after electrochemical formation and/or prelithiation, these densities may change, but may still be within one of the listed ranges.

In some embodiments, the silicon-containing anode active material (e.g., silicon, germanium or alloys thereof) of the lithium storage layer, e.g., a continuous porous lithium storage layer, may have substantial lateral connectivity across portions of the current collector creating, such connectivity extending around random pores and interstices. Referring again to FIG. 6A, in some embodiments, “substantial lateral connectivity” means that active material at one point X in the continuous porous lithium storage layer 607 may be connected to active material at a second point X′ in the layer at a straight-line lateral distance LD that is at least as great as the average thickness T of the lithium storage layer, alternatively, a lateral distance at least 2 times as great as the thickness, alternatively, a lateral distance at least 3 times as great as the thickness. Not shown, the total path distance of material connectivity, including circumventing pores and following the topography of the current collector, may be longer than LD. In some embodiments, the continuous porous lithium storage layer may be described as a matrix of interconnected silicon with random pores and interstices embedded therein. In some embodiments, the silicon-containing anode active material layer, e.g., a continuous porous lithium storage layer, may in a cross-sectional view have a sponge-like form. It should be noted that the lithium storage layer, e.g., a continuous porous lithium storage layer, does not necessarily extend across the entire anode without any lateral breaks and may include numerous random discontinuities or cracks and still be considered continuous. In some embodiments, such discontinuities may occur more frequently on rough current collector surfaces. In some embodiments, the silicon-containing anode active material layer, e.g., a continuous porous lithium storage layer, may in a cross-sectional view appear to have abutting columns of anode active material. The abutting columns may be characterized by an average height and average width, and generally have a height-to-width aspect ratio of less than 4:1, alternatively less than 3:1, alternatively less than 2:1, alternatively less than 1:1. Such abutting columns are generally laterally continuous. In some embodiments, the silicon-containing anode active material layer, e.g., a continuous porous lithium storage layer, may include a matrix of connected nanoparticle aggregates. In some embodiments, the silicon-containing anode active material layer may include a mixture of amorphous and crystalline silicon, e.g., nano-crystalline silicon having an average grain size of less than about 100 nm, alternatively less than about 50 nm, 20 nm, 10 nm, or 5 nm. In some cases, the silicon-containing anode active material layer may include up to 30 atomic % nano-crystalline silicon relative to all silicon in the lithium storage layer.

In some embodiments, the silicon-containing anode active material layer, e.g., a continuous porous lithium storage layer, includes a sub-stoichiometric oxide of silicon (SiOₓ), and optionally germanium (GeOₓ) or tin (SnOₓ) wherein the ratio of oxygen atoms to silicon, germanium or tin atoms is less than 2:1, i.e., x<2, alternatively less than 1:1, i.e., x<1. In some embodiments, x is in a range of 0.02 to 0.95, alternatively 0.02 to 0.10, alternatively 0.10 to 0.50, or alternatively 0.50 to 0.95, alternatively 0.95 to 1.25, alternatively 1.25 to 1.50, or any combination of ranges thereof. A lithium storage layer having a sub-stoichiometric oxide of silicon may also be referred to as oxygen-doped silicon.

In some embodiments, the silicon-containing anode active material layer, e.g., a continuous porous lithium storage layer, includes a sub-stoichiometric nitride of silicon (SiN_{y}) and optionally germanium (GeN_{y}) or tin (SnN_{y}) wherein the ratio of nitrogen atoms to silicon, germanium or tin atoms is less than 1.25:1, i.e., y<1.25. In some embodiments, y is in a range of 0.02 to 0.95, alternatively 0.02 to 0.10, alternatively 0.10 to 0.50, or alternatively 0.50 to 0.95, alternatively 0.95 to 1.20, or any combination of ranges thereof. A lithium storage layer having a sub-stoichiometric nitride of silicon may also be referred to as nitrogen-doped silicon or a silicon-nitrogen alloy.

In some embodiments, the silicon-containing anode active material layer, e.g., a continuous porous lithium storage layer, includes a sub-stoichiometric oxynitride of silicon (SiOₓN_{y}) and optionally germanium (GeOₓN_{y}), or tin (SnOₓN_{y}) wherein the ratio of total oxygen and nitrogen atoms to silicon, germanium or tin atoms is less than 1:1, i.e., (x+y)<1. In some embodiments, (x+y) is in a range of 0.02 to 0.95, alternatively 0.02 to 0.10, alternatively 0.10 to 0.50, or alternatively 0.50 to 0.95, or any combination of ranges thereof.

In some embodiments, the above sub-stoichiometric oxides, nitrides or oxynitrides are provided by a CVD process, including but not limited to, a PECVD process. The oxygen and nitrogen may be provided uniformly within the continuous porous lithium storage layer, or alternatively the oxygen or nitrogen content may be varied as a function of storage layer thickness. Including some sub-stoichiometric oxides, nitrides, or oxynitrides of silicon may provide an anode active material layer that has less expansion upon lithiation than substantially pure silicon.

### CVD

CVD generally involves flowing a precursor gas, a gasified liquid in terms of direct liquid injection CVD or gases and liquids into a chamber containing one or more objects, typically heated, to be coated. Chemical reactions may occur on and near the hot surfaces, resulting in the deposition of a thin film on the surface. This is accompanied by the production of chemical by-products that are exhausted out of the chamber along with unreacted precursor gases. As would be expected with the large variety of materials deposited and the wide range of applications, there are many variants of CVD that may be used to form the lithium storage layer, the surface layer or sublayer, a supplemental layer (see below) or other layers. It may be done in hot-wall reactors or cold-wall reactors, at sub-torr total pressures to above-atmospheric pressures, with and without carrier gases, and at temperatures typically ranging from 100-1600° C. in some embodiments. There are also a variety of enhanced CVD processes, which involve the use of plasmas, ions, photons, lasers, hot filaments, or combustion reactions to increase deposition rates and/or lower deposition temperatures. Various process conditions may be used to control the deposition, including but not limited to, temperature, precursor material, gas flow rate, pressure, substrate voltage bias (if applicable), and plasma energy (if applicable).

As mentioned, a silicon-containing anode active material layer such as a continuous porous lithium storage layer, may be provided by plasma-enhanced chemical vapor deposition (PECVD). Relative to some other CVD processes, deposition by PECVD can often be done at lower temperatures and higher rates, which can be advantageous for higher manufacturing throughput. In some embodiments, the PECVD is used to deposit a substantially amorphous silicon layer (optionally doped) over the surface layer. In some embodiments, PECVD is used to deposit a substantially amorphous continuous porous silicon layer over the surface layer.

In PECVD processes, according to various implementations, a plasma may be generated in a chamber in which the substrate is disposed or upstream of the chamber and fed into the chamber. Various types of plasmas may be used including, but not limited to, capacitively-coupled plasmas, inductively-coupled plasmas, and conductive coupled plasmas. Any appropriate plasma source may be used, including DC, AC, RF, VHF, hollow cathode, combinatorial PECVD and microwave sources may be used. In some embodiments, magnetron assisted RF PECVD may be used.

PECVD process conditions (temperatures, pressures, precursor gases, carrier gasses, dopant gases, flow rates, energies, and the like) can vary according to the particular process and tool used, as is well known in the art.

In some implementations, the PECVD process is an expanding thermal plasma chemical vapor deposition (ETP-PECVD) process. In such a process, a plasma generating gas is passed through a direct current arc plasma generator to form a plasma, with a web or other substrate including the current collector optionally in an adjoining vacuum chamber. A silicon source gas is injected into the plasma, with radicals generated. The plasma is expanded via a diverging nozzle and injected into the vacuum chamber and toward the substrate. An example of a plasma generating gas is argon (Ar). In some embodiments, the ionized argon species in the plasma collide with silicon source molecules to form radical species of the silicon source, resulting in deposition onto the current collector.

Any appropriate silicon source may be used to deposit silicon. In some embodiments, the silicon source may be a silane-based precursor gas including, but not limited to, silane (SiH₄), dichlorosilane (H₂SiCl₂), monochlorosilane (H₃SiCl), trichlorosilane (HSiCl₃), silicon tetrachloride (SiCl₄), disilane, tetrafluorosilane, triethylsilane, and diethylsilane. Depending on the gas(es) used, the silicon layer may be formed by decomposition or reaction with another compound, such as by hydrogen reduction. In some embodiments, the gases may include a silicon source such as silane, a noble gas such as helium, argon, neon, or xenon, optionally one or more dopant gases, and substantially no hydrogen. In some embodiments, the gases may include argon, silane, and hydrogen, and optionally some dopant gases. In some embodiments the gas flow ratio of argon relative to the combined gas flows for silane and hydrogen is at least 3.0, alternatively at least 4.0. In some embodiments, the gas flow ratio of argon relative to the combined gas flows for silane and hydrogen is in a range of 3-5, alternatively 5-10, alternatively 10-15, alternatively 15-20, or any combination of ranges thereof. In some embodiments, the gas flow ratio of hydrogen gas to silane is in a range of 0-0.1, alternatively 0.1-0.2, alternatively 0.2-0.5, alternatively 0.5-1, alternatively 1-2, alternatively 2-5, or any combination of ranges thereof. In some embodiments, higher porosity silicon may be formed and/or the rate of silicon deposition may be increased when the gas flow ratio of silane relative to the combined gas flows of silane and hydrogen increases. Higher porosity may in some cases allow for reduced silicon layer expansion during charging. In some embodiments a dopant gas is borane or phosphine, which may be optionally mixed with a carrier gas. In some embodiments, the gas flow ratio of dopant gas (e.g., borane or phosphine) to silicon source gas (e.g., silane) is in a range of 0.0001-0.0002, alternatively 0.0002-0.0005, alternatively 0.0005-0.001, alternatively 0.001-0.002, alternatively 0.002-0.005, alternatively 0.005-0.01, alternatively 0.01-0.02, alternatively 0.02-0.05, alternatively 0.05-0.10, or any combination of ranges thereof. Such gas flow ratios described above may refer to the relative gas flow, e.g., in standard cubic centimeters per minute (SCCM). In some embodiments, the PECVD deposition conditions and gases may be changed over the course of the deposition.

In some embodiments, the temperature at the current collector during at least a portion of the time of PECVD deposition is in a range of 20° C. to 50° C., 50° C. to 100° C., alternatively 100° C. to 200° C., alternatively 200° C. to 300° C., alternatively 300° C. to 400° C., alternatively 400° C. to 500° C., alternatively 500° C. to 600° C., or any combination of ranges thereof. In some embodiments, the temperature may vary during the time of PECVD deposition. For example, the temperature during early times of the PECVD may be higher than at later times. Alternatively, the temperature during later times of the PECVD may be higher than at earlier times.

The thickness or mass per unit area of the silicon-containing anode active material layer, e.g., a continuous porous lithium storage layer, depends on the storage material, desired charge capacity and other operational and lifetime considerations. Increasing the thickness typically provides more capacity. If the lithium storage layer becomes too thick, electrical resistance may increase and the stability may decrease. In some embodiments, the anode may be characterized as having an active silicon areal density of at least 0.2 mg/cm², alternatively at least 0.5 mg/cm², alternatively at least 1.0 mg/cm², alternatively at least 1.5 mg/cm², alternatively at least 3 mg/cm², alternatively at least 5 mg/cm². In some embodiments, the lithium storage structure may be characterized as having an active silicon areal density in a range of 0.2-0.5 mg/cm², alternatively in a range of 0.5-1.0 mg/cm², alternatively in a range of 1.0-1.5 mg/cm², alternatively in a range of 1.5-2 mg/cm², alternatively in a range of 2-3 mg/cm², alternatively in a range of 3-5 mg/cm², alternatively in a range of 5-10 mg/cm², alternatively in a range of 10-15 mg/cm², alternatively in a range of 15-20 mg/cm², or any combination of ranges thereof. “Active silicon” refers to the silicon in electrical communication with the current collector that is available for reversible lithium storage at the beginning of cell cycling, e.g., after anode “electrochemical formation” discussed later. “Areal density” refers to the surface area of the electrically conductive layer over which active silicon is provided. In some embodiments, not all of the silicon content is active silicon, i.e., some may be tied up in the form of non-active silicides or may be electrically isolated from the current collector.

In some embodiments the silicon-containing anode active material layer, e.g., a continuous porous lithium storage layer, has an average thickness of at least 0.5 μm, alternatively at least 1 μm, alternatively at least 2.5 μm, alternatively at least 5 μm, alternatively at least 6.5 μm. In some embodiments, the lithium storage layer, e.g., a continuous porous lithium storage layer, has an average thickness in a range of about 0.5 μm to about 50 μm. In some embodiments, the silicon-containing anode active material layer deposited by a PVD or CVD process, e.g., a continuous porous lithium storage layer, comprises at least 80 atomic % amorphous silicon and has a thickness in a range of 1-1.5 μm, alternatively 1.5-2.0 μm, alternatively 2.0-2.5 μm, alternatively 2.5-3.0 μm, alternatively 3.0-3.5 μm, alternatively 3.5-4.0 μm, alternatively 4.0-4.5 μm, alternatively 4.5-5.0 μm, alternatively 5.0-5.5 μm, alternatively 5.5-6.0 μm, alternatively 6.0-6.5 μm, alternatively 6.5-7.0 μm, alternatively 7.0-8.0 μm, alternatively 8.0-9.0 μm, alternatively 9.0-10 μm, alternatively 10-15 μm, alternatively 15-20 μm, alternatively 20-25 μm, alternatively 25-30 μm, alternatively 30-40 μm, alternatively 40-50 μm, or any combination of ranges thereof.

In some embodiments, rather than depositing the silicon-containing anode active material by CVD (e.g., PECVD), it may be formed by a physical vapor deposition (PVD) process such as by sputtering. Although the deposition rates of sputtering are typically lower than PECVD, sputtering may be suitable for some applications, e.g., those that require relatively lower loadings of the active material such as silicon. For example, in some embodiments, a lithium storage layer, e.g., a continuous porous lithium storage layer, formed by a sputtering process may have a thickness of less than about 15 μm, alternatively less than about 10 μm, alternatively less than 7 μm, alternatively less than 5 μm, alternatively less than 3 μm.

In some embodiments, the silicon-containing anode active material layer may include nanowires deposited by a CVD process, e.g., as described in U.S. Pat. Nos. 8,257,866, 9,923,201, US20100285358, US20100330421, US20110159365, US20130143124, US20140248543, US20150118572, US20150325852, and US20170338464, the entire contents of which are incorporated by reference herein for all purposes.

In some embodiments, the silicon-containing anode active material layer may include a slurry-coated active material including silicon or a sub-stoichiometric silicon oxide, typically along with a carbon-based binder, conductive carbon, or the like. While a slurry-coated silicon-containing active material layer may be used for both sides of the anode, in some cases, it is advantageous that at least one of the lithium storage layers is deposited by a CVD or PVD process. Some non-limiting examples of slurry-coated silicon-containing active material layers are described in U.S. Pat. Nos. 11,183,689, 11,450,850, US20230056009, U.S. Pat. Nos. 7,316,792, and 8,597,831, the entire contents of which are incorporated by reference herein for all purposes.

### Other Anode Features

The anode may optionally include various additional layers and features. In some embodiments, a supplemental layer is provided over the lithium storage layer. In some embodiments, the supplemental layer is a protection layer to enhance lifetime or physical durability. The supplemental layer may be an oxide formed from the lithium storage material itself, e.g., silicon dioxide in the case of silicon, or some other suitable material. A supplemental layer may be deposited, for example, by ALD, S-ALD, CVD, i-CVD, PECVD, MLD, evaporation, sputtering, solution coating, ink jet or any method that is compatible with the anode. In some embodiments, the top surface of the supplemental layer may correspond to a top surface of the anode.

A supplemental layer should be reasonably conductive to lithium ions and permit lithium ions to move into and out of the patterned lithium storage structure during charging and discharging. In some embodiments, the lithium-ion conductivity of a supplemental layer is at least 10-9 S/cm, alternatively at least 10-8 S/cm, alternatively at least 10-7 S/cm, alternatively at least 10-6 S/cm. In some embodiments, the supplemental layer acts as a solid-state electrolyte.

Some non-limiting examples of materials used in a supplemental layer include metal oxides, nitrides, or oxynitrides, e.g., those containing aluminum, titanium, vanadium, zirconium, hafnium, or tin, or mixtures thereof. The metal oxide, metal nitride or metal oxynitride may include other components such as phosphorous or silicon. The supplemental layer may include a lithium-containing material such as lithium phosphorous oxynitride (LIPON), lithium phosphate, lithium aluminum oxide, (Li,La)ₓTi_{y}O_{z}, or LiₓSi_{y}Al₂O₃. In some embodiments, the supplemental layer includes a metal oxide, metal nitride, or metal oxynitride, and has an average thickness of less than about 100 nm, for example, in a range of about 0.1 to about 10 nm, or alternatively in a range of about 0.2 nm to about 5 nm. LIPON or other solid-state electrolyte materials having superior lithium transport properties may have a thickness of more than 100 nm, but may alternatively, be in a range of about 1 to about 50 nm. In some embodiments, LIPON or other solid-state electrolyte material may have a thickness in the range of 0.1-0.5 μm, alternatively 0.5-1.0 μm, alternatively 1-1.5 μm, alternatively 1.5-2.0 μm, alternatively 2.0-2.5 μm, alternatively 2.5-3.0 μm, alternatively 3.0-3.5 μm, alternatively 3.5-4.0 μm, alternatively 4.0-4.5 μm, alternatively 4.5-5.0 μm, alternatively 5.0-5.5 μm, alternatively 5.5-6.0 μm, alternatively 6.0-6.5 μm, alternatively 6.5-7.0 μm, alternatively 7.0-8.0 μm, alternatively 8.0-9.0 μm, alternatively 9.0-10 μm, alternatively 10-15 μm, alternatively 15-20 μm, alternatively 20-25 μm, alternatively 25-30 μm, alternatively 30-40 μm, alternatively 40-50 μm, or any combination of ranges thereof.

### Prelithiation

In some embodiments, the silicon-containing anode active material layer, e.g., a continuous porous lithium storage layer, may be at least partially prelithiated prior to a first electrochemical cycle after battery assembly, or alternatively prior to battery assembly. That is, some lithium may be incorporated into the silicon-containing anode active material layer to form a lithiated storage layer even prior to a first battery cycle. In some embodiments, the lithiated storage layer may break into smaller structures, including but not limited to platelets or segments, that remain electrochemically active and continue to reversibly store lithium. Note that “lithiated storage layer” simply means that at least some of the potential storage capacity of the lithium storage layer is filled, but not necessarily all. In some embodiments, the lithiated storage layer may include lithium in a range of 1% to 5% of the theoretical lithium storage capacity of the lithium storage layer, alternatively 5% to 10%, alternatively 10% to 15%, alternatively 15% to 20%, alternatively, 20% to 30%, alternatively 30% to 40%, alternatively 40% to 50%, alternatively 50% to 60%, alternatively 60% to 70%, alternatively 70% to 80%, alternatively 80% to 90%, alternatively 90% to 100%, or any combination of ranges thereof. In some embodiments, a surface layer may capture some of the lithium, and one may need to account for such capture to achieve the desired lithium range in the lithiated storage layer.

In some embodiments, prelithiation may include physical contact of the silicon-containing anode active material with a lithiation material. The lithiation material may include a reducing lithium compound, lithium metal or a stabilized lithium metal powder. Such materials may be contacted directly with the anode active material, or alternatively, may be provided as a coating on a lithium transfer substrate. The lithium transfer substrate may include a metal (e.g., as a foil), a polymer, a ceramic, or some combination of such materials, optionally in a multilayer format. In some embodiments, such lithiation material may be provided on at least one side of a separator that faces the anode, i.e., the separator also acts as a lithium transfer substrate. In some embodiments, lithiation materials may be applied with pressure and/or heat to promote lithium transfer into the continuous lithium storage layer, optionally through one or more supplemental layers. In some embodiments a pressure applied between an anode and a lithiation material may be at least 200 kPa, alternatively at least 1000 kPa, alternatively at least 5000 kPa. Pressure may be applied, for example, by calendering, pressurized plates, or in the case of a lithiation material coating on a separator, by assembly into battery having confinement or other pressurizing features.

In some embodiments prelithiation may include depositing lithium metal over the silicon-containing anode active material layer, e.g., one deposited by a CVD or PVD process, alternatively between one or more lithium storage sublayers, or both, e.g., by evaporation, e-beam or sputtering. This may optionally be done in-line when manufacturing the silicon-containing anode active material layer by CVD or PVD.

In some embodiments the anode may be thermally treated prior to battery assembly. In some embodiments, thermally treating the anode may improve adhesion of the various layers or electrical conductivity, e.g., by inducing migration of metal from the current collector or atoms from the optional supplemental layer into the lithium storage layer.

In some embodiments, the silicon-containing anode active material layer, e.g., a continuous porous lithium storage layer, includes at least 0.05 atomic % of one or more transition metals, alternatively at least 0.1 atomic %, alternatively at least 0.2 atomic %, alternatively at least 0.5 atomic %, alternatively at least 1 atomic % of transition metal. In some embodiments, the silicon-containing anode active material layer includes less than about 10 atomic % of one or more transition metals, alternatively less than 5 atomic %, alternative less than 2 atomic %, alternatively less than 1 atomic %, alternatively less than 0.5 atomic %, alternatively less than 0.3 atomic %. In some embodiments, the silicon-containing anode active material layer may include one or more transition metals in an atomic % range of 0.05-0.1%, alternatively 0.1-0.2%, alternatively 0.2-0.5%, alternatively 0.5-1%, alternatively 1-2%, alternatively 2-3%, alternatively 3-5%, alternatively 5-7%, alternatively 7-10%, or any combination of ranges thereof. In some embodiments, the aforementioned ranges of atomic % the transition metal(s) may correspond to a cross-sectional area of the lithium storage layer of at least 1 μm², which may be measured, e.g., by energy dispersive x-ray spectroscopy (EDS). In some embodiments, the transition metal atomic % values above may represent the atomic % of one transition metal or alternatively may correspond to the combined atomic % when there is mixture of transition metals. Some non-limiting examples of transition metals that may be present in the lithium storage layer include copper, nickel, titanium, vanadium, and molybdenum. In some embodiments, there is a gradient where the concentration of the transition metal in portions of the lithium storage layer near the current collector is higher than portions further from the current collector. In some embodiments, the silicon-containing anode active material layer may include a transition metal that is the same as a transition metal found in the electrically conductive layer or the surface layer transition metallate. In some cases, the one or more transition metals may be provided in the silicon-containing anode active material layer by thermal treatments to cause migration of the metal into the lithium storage layer, but other methods may be used, such as co-deposition of the lithium storage material and the metal.

In some embodiments, thermally treating the anode may be done in a controlled environment having a low oxygen and water (e.g., less than 10 ppm or partial pressure of less than 0.1 Torr, alternatively less than 0.01 Torr content to prevent degradation). In some embodiments, anode thermal treatment may be carried out using an oven, infrared heating elements, contact with a hot plate or exposure to a flash lamp. The anode thermal treatment temperature and time depend on the materials of the anode. In some embodiments, anode thermal treatment includes heating the anode to a temperature of at least 50° C., optionally in a range of 50° C. to 950° C., alternatively 100° C. to 250° C., alternatively 250° C. to 350° C., alternatively 350° C. to 450° C., alternatively 450° C. to 550° C., alternatively 550° C. to 650° C., alternatively 650° C. to 750° C., alternatively 750° C. to 850° C., alternatively 850° C. to 950° C., or a combination of these ranges. In some embodiments, the thermal treatment may be applied for a time period of 0.1 to 120 minutes.

In some embodiments one or more processing steps described above may be performed using roll-to-roll methods wherein the electrically conductive layer or current collector is in the form of a rolled film, e.g., a roll of metal foil, a conductive mesh or a conductive carbon fabric.

### Cathode

Positive electrode (cathode) materials include, but are not limited to, lithium metal oxide compounds (e.g., LiCoO₂ (aka “LCO”), LiFePO₄ (aka “LFP”), LiMnₓFe_{y}PO₄ (aka “LMFP”), LiNiₓMnₓO₄ (aka “LNMO”), LiMnO₂, LiNiO₂, LiMn₂O₄ (aka “LMO”), LiCoPO₄, LiNiₓCo_{y}Mn_{z}O₂ (aka “NMC”), LiNiₓCo_{y}Al_{z}O₂ (aka “NCA”), LiFe₂(SO₄)₃, or Li₂FeSiO₄), carbon fluoride, metal fluorides such as iron fluoride (FeF₃), metal oxide, sulfur, selenium and combinations thereof. Cathode active materials may operate, e.g., by intercalation, conversion, or a combination. Cathode active materials may in some cases be mixed with one or more binders and coated over the cathode current collector to form the cathode. In some embodiments, a cathode current collector may include a metal foil, mesh, or sheet of a conductive material such as aluminum. In some cases, a cathode current collector may include a metal coating such as aluminum provided over an electrically insulating polymer. In some cases, the cathode current collector may be a film, paper, fiber, or sheet that includes an electrically conductive carbon, such as carbon black, carbon nanotubes, graphene, graphene oxide, reduced graphene oxide, and graphite. In some embodiments, the electrically conductive layer may be in the form of a foil, a conductive mesh, or a sheet of conductive material.

### Separator

The separator allows ions to flow between the anode and cathode but prevents direct electrical contact. Such separators are typically porous sheets or other free-standing films, and along with electrolyte, occupies at least a portion of the space between the anode and cathode. Depending on cell design, a separator may be in physical contact with the cathode, the anode, both the anode and cathode, or neither the anode nor cathode. Non-aqueous lithium-ion separators may include single layer or multilayer polymer sheets, typically made of polyolefins such as polyethylene or polypropylene, but polyethylene terephthalate (PET) and polyvinylidene fluoride (PVdF) can also be used and numerous other synthetic or naturally occurring polymers may be used. Cellulose-based materials are another polymeric material that may be useful. For example, a separator can have >30% porosity, low ionic resistivity, a thickness of ~10 to 70 μm. In some cases, a separator has high bulk puncture strengths. Separators may alternatively include glass materials, ceramic materials, a ceramic material embedded in a polymer, a polymer coated with a ceramic, or some other composite or multilayer structure, e.g., to provide higher mechanical and thermal stability. In some embodiments, a separator may include a polymer that may be provided as a film, and which is highly elastic and/or has gel-like properties in the presence of liquid electrolyte.

### Compressible Elements

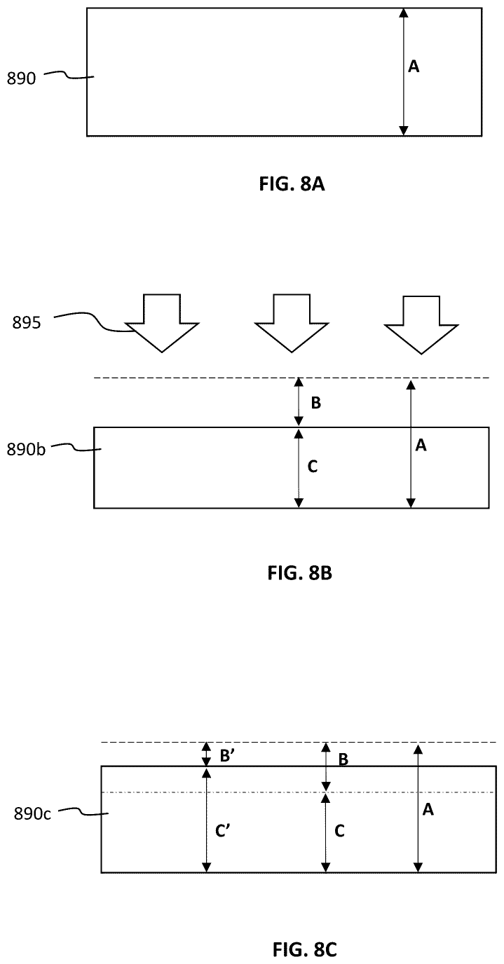

Some embodiments disclosed herein relate to various elements that may be compressible under pressure, e.g., a pressure caused directly or indirectly by silicon expansion during electrochemical cycling such as an electrochemical charging event (e.g., lithiation of the silicon). FIG. 8A is a cross-sectional view of a compressible element 890 according to some embodiments. As discussed elsewhere herein, compressible element 890 may be, for example, a compressible separator, a compressible current collector, a compressible liner, a compressible central element, a compressible cathode active material layer, or a compressible solid-state electrolyte layer. For example, compressible element 890 may be formed of a compressible material and/or have a compressible/collapsible structure.

In FIG. 8A, compressible element 890 may have a thickness A, which may represent a thickness before electrochemical cycling such as an electrochemical charging event, or when the cell is in a state of discharge where the anode is storing less than 30% of its operational lithium storage capacity, alternatively less than 20%, or alternatively less than 10%. Compressible element 890 may be referred to as being in an initial state.

In FIG. 8B, a pressure 895 is applied so that compressible element 890b has a compressed thickness C that is less than initial state thickness A by an amount B. In FIG. 8B, compressible element 890b is in a compressed state. For example, the pressure may be caused by electrochemical cycling such as an electrochemical charging event. In some embodiments, a compressible element is one that, during at least one electrochemical charging event, is compressible to less than 95% of its thickness prior to the electrochemical charging event. That is, the compressibility ratio C/A (which may alternatively be expressed as a “compressibility percent”) is less than 0.95 (95%), or alternatively, ratio B/A is greater than 0.05. In some cases, the compressible element is compressible to less than 90%, 85%, 80%, 75%, or 70% of its thickness prior to the electrochemical charging event. In some cases, ratio C/A may be in a range of 0.1-0.3, 0.3-0.5, 0.5-0.6, 0.6-0.7, 0.7-0.75, 0.75-0.80, 0.80-0.85, 0.85-0.90, 0.90-0.94, or any combination of ranges thereof.

FIG. 8C shows the compressible element after an electrochemical discharge event according to some embodiments, where after at least some of the pressure 895 has been reduced, the compressible element 895c has a thickness C′. In some embodiments (as shown here), C′ is still less than A (by B′), but greater than C. That is, when pressure 895 is relieved, the thickness of the compressible element is partially restored. In some cases, C′=A, and the compressible element is reversibly compressible. In general, when C′/A is equal to or greater than 0.95, the compressible element may be considered to be substantially reversibly compressible. In some cases, C′=C (or B′=B) and the compressible element is irreversibly compressible. In general, when B′/B is 0.95 or more, the compressible element may be considered to be substantially irreversibly compressible. In general, when B′/B is less than 0.95 and C′/A less than 0.95, the compressible element may be considered partially irreversibly compressible (or it may equally be referred to as partially reversibly compressible).

In some embodiments, the pressure 895 needed to compress the compressible element to less than 95%, or alternatively less than 90%, 85%, 80%, 75%, or 70% of its initial thickness is no more than 100 MPa, alternatively no more than 50 MPa, 20 MPa, 10 MPa, 5 MPa, 2 MPa, 1 MPa, 0.5 MPa, 0.2 MPa, or 0.1 MPa. In some cases, such pressure may be in a range of 0.01-0.02 MPa, 0.02-0.05 MPa, 0.05-0.1 MPa, 0.1-0.2 MPa, 0.2-0.5 MPa, 0.5-1 MPa, 1-2 MPa, 2-5 MPa, 5-10 MPa, 10-20 MPa, 20-50 MPa, 50-100 MPa, or any combination of ranges thereof. In some cases, an element is considered incompressible if the compressibility percent is not lower than 95% under a pressure of 100 MPa.

In some embodiments, a compressible element may be characterized by a flexural yield strength of less than 100 MPa, alternatively less than 50 MPa, 20 MPa, 10 MPa, 5 MPa, 2 MPa, 1 MPa, 0.5 MPa, 0.2 MPa, or 0.1 MPa. In some cases, the flexural yield strength of a compressible element may be in a range of 0.01-0.02 MPa, 0.02-0.05 MPa, 0.05-0.1 MPa, 0.1-0.2 MPa, 0.2-0.5 MPa, 0.5-1 MPa, 1-2 MPa, 2-5 MPa, 5-10 MPa, 10-20 MPa, 20-50 MPa, 50-100 MPa, or any combination of ranges thereof.

### Compressible Separator

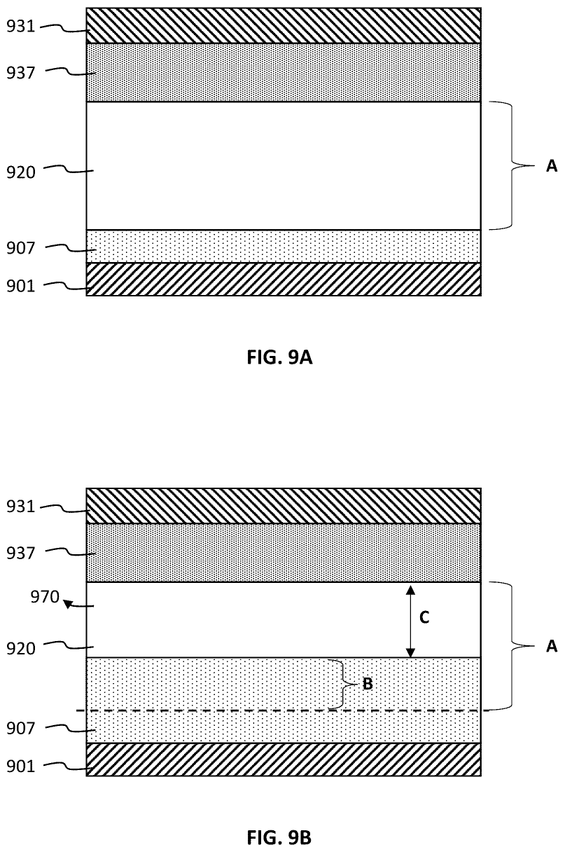

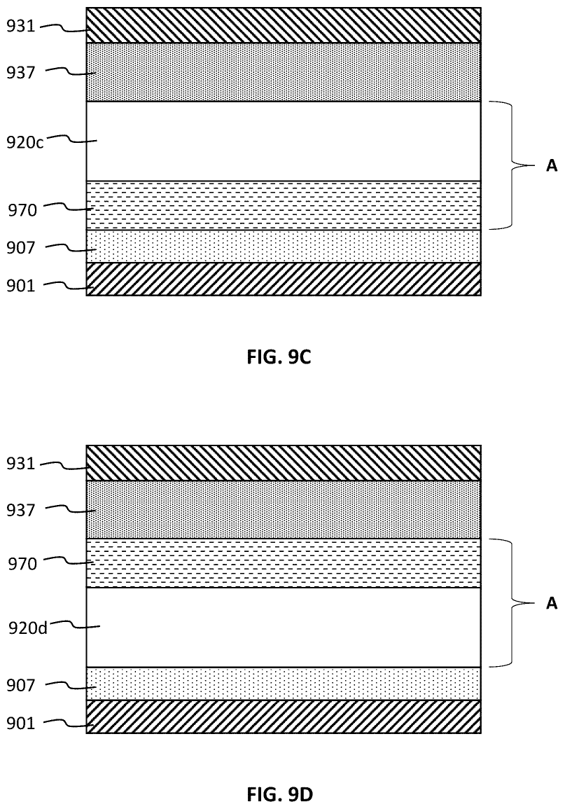

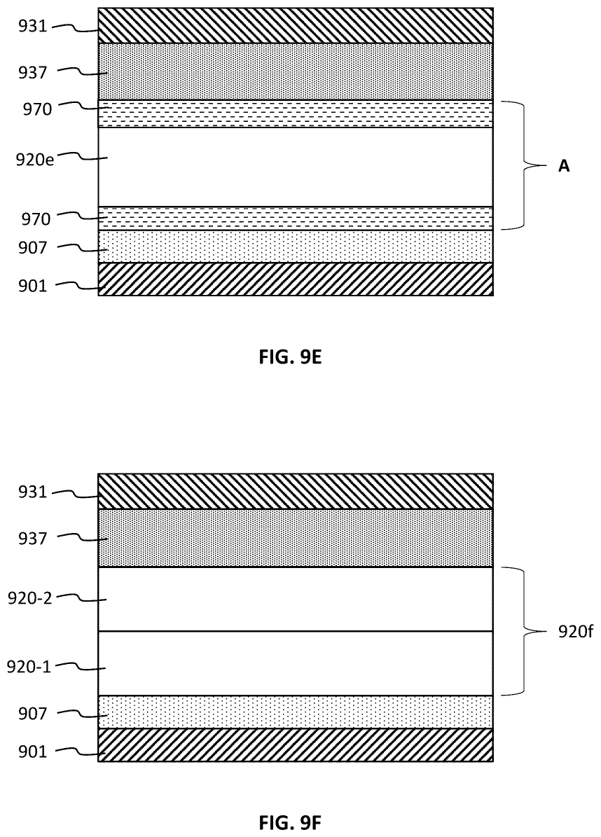

In some embodiments, one or more separators may be compressible during battery operation or cycling. That is, the compressible element may be a separator. A separator may include a compressible material and/or have a compressible structure. FIGS. 9A-9F are cross-sectional schematics of a portion of a battery cell having a compressible separator according to various embodiments. A compressible separator 920 is disposed between a silicon-containing active material layer 907 (provided on one side of anode current collector 901) and a cathode active material layer 937 (provided on one side of cathode current collector 931). The pores and open spaces of compressible separator 920 may include a nonaqueous lithium-ion electrolyte 970 also disposed between the anode and cathode active material layers. FIG. 9A may represent the battery cell before any electrochemical cycling or when the cell is in a state of substantial discharge where the anode is storing less than 30% of its operational lithium storage capacity, alternatively less than 20%, or alternatively less than 10%. The battery cell is in its initial state. Separator 920 may be characterized by an initial thickness A as discussed with respect to FIGS. 8A-8C

In FIG. 9B, the battery cell has undergone an electrochemical charging event or cycle to be in a charged state, where the anode is storing 30% or more of its operational lithium storage capacity. As mentioned, silicon expands upon lithiation. Rather than transferring expansion forces fully to the cell housing, the compressible separator absorbs some of this and is compressed by an amount B to a compressed thickness C. In some embodiments, during compression of the separator, some of the electrolyte 970 may move out of the separator and to an electrolyte reservoir or pocket provided in the cell (not shown). In some embodiments, an electrolyte reservoir may be characterized by a reservoir volume that, relative to a total internal cell volume not occupied by the battery assembly, is in a range of 0.1-0.5%, 0.5-1.0%, 1-2%, 2-5%, 5-10%, 10-15%, or any combination of ranges thereof. In some cases, an electrolyte reservoir may be contained by a bladder structure that can expand and contract within the internal cell as needed.

In some embodiments, a separator may be substantially reversibly compressible, and upon a subsequent discharge event, the cell may appear similar to that shown in FIG. 9A. In some embodiments, if any electrolyte 970 had moved to a reservoir, it may flow back into the separator pores/spaces upon cell discharge. In some embodiments, a substantially reversible separator may include a highly elastic polymer material or have gel-like properties in the presence of liquid electrolyte.

In some embodiments, a separator may be at least partially irreversibly compressible. In the case when a separator is partially or substantially irreversibly compressible, the separator may upon a discharge event stay in contact mostly with the cathode (separator 920c, FIG. 9C), alternatively mostly with the anode (separator 920d, FIG. 9D), alternatively be substantially separate from both (separator 920e, FIG. 9E), or alternatively some combination of these situations across the battery cell. In some embodiments, if some of electrolyte 970 had flowed into a reservoir during charging, it may flow into the new space created by the modified separator structure.

A compressible (reversible or irreversible) separator generally includes a polymeric material (which may include a synthetic polymer and/or a naturally occurring polymer, such as a cellulosic material). The polymeric material may have some elasticity. As mentioned, the separator may include pores and channels where electrolyte may be present/stored. In some embodiments, the separator may also include (define) electrolyte-free pockets, e.g., micro- or nano-pockets, that are void or gas-containing, and preferably remain electrolyte-free. The internal pockets may be in the form of trapped bubbles. Such pockets may be readily compressible and reduce the possible need or volume for an electrolyte reservoir to capture electrolyte that is squeezed out of the separator during compression. Hence, the separator may have a compressible structure. A compressible separator or portions thereof may have the appearance of a foam in cross-section.

A separator may have a multilayer structure. In some embodiments as shown in FIG. 9F, separator 920f may include a separator sublayer 920-1 adjacent to the anode active material layer 907, and a separator sublayer 920-2 adjacent to the cathode active material layer 937. Although not shown, the separator may include additional sublayers between 920-1 and 920-2. In some embodiments, separator sublayer 920-1 may be less compressible relative to separator sublayer 920-2. For example, separator sublayer 920-1 may include a ceramic material and separator sublayer 920-2 may include a compressible polymeric material (reversible or irreversible). A few non-limiting examples of ceramic materials include oxides of Al, Ti, P, Si, Li, Ta, Zr, and La, and mixtures thereof. Although expansion of silicon-containing anode active material layer 907 during charging may be uniform, there may sometimes be hot spots where expansion is greater than in other areas. When separator sublayer 920-1 has low or no substantial compressibility, a force applied by the hot spot may be distributed along the separator sublayer 920-1 and transferred more uniformly to the cathode active material layer through more compressible separator sublayer 920-2. Further, the less compressible separator sublayer may act to suppress hot spot formation by providing a firm counterforce to an expanding area of the anode and promote more uniform utilization of the entire anode.

In some other cases, it may be advantageous for separator sublayer 920-2 to be less compressible relative to separator sublayer 920-1. For example, separator sublayer 920-2 may include a porous ceramic material and separator sublayer 920-1 may include a compressible polymeric material. In some cases, having a compressible separator material adjacent the anode may reduce the likelihood that the silicon-containing anode active material layer will break apart during expansion and promote longer cycle life.

Although not illustrated, the separator may include three or more sublayers, where in some embodiments, at least one of the two separator sublayers adjacent the active material layers include a more compressible material (e.g., polymeric) than one or more interior sublayers (e.g., a ceramic). Alternatively, at least one of the two separator sublayers adjacent the active material layers may include a less compressible material (e.g., a ceramic) than one or more interior sublayers (e.g., polymeric). In some cases, a separator structure may even provide a gradient of increasing or decreasing compressibility.

In the above comparisons, the less compressible separator material may be something other than ceramic, e.g., a low-compressibility polymer. In some cases, the more compressible polymeric separator material may include a cellulose-based material or a polymer film having gel-like or elastic properties.

In some embodiments, a separator may include a material or coating that promotes wetting of electrolyte. This may improve cell performance (e.g., uniformity across the electrodes) or aid manufacturing steps such as electrolyte filling.

### Compressible Liners/Compressible Central Element

In some embodiments, a battery cell may include a compressible liner along its wall(s) or around a central element, as mentioned elsewhere. In some cases, the central element may be a compressible central element. In some embodiments, a compressible liner or central element may be similar to the materials and structures described with respect to separators. A compressible liner or central element may be a compressible element that is substantially reversibly compressible, at least partially irreversibly compressible, completely irreversibly compressible, or even incompressible. Unlike separators, however, there is no porosity requirement to allow electrolyte and ions to flow through it. For example, the compressible liner or central element may be non-porous. In some cases, it may be advantageous that at the compressible liner or central element not substantially absorb or contain electrolyte. In some cases, the compressible liner or central element may include a polymeric material that includes pockets that are void or gas-containing, and preferably remain electrolyte-free. Such pockets may be relatively large, or alternatively, micro- or nano-pockets. The internal pockets may be in the form of trapped bubbles. Such pockets may be readily compressible and reduce the possible need for an electrolyte reservoir (or reduce its volume) to capture electrolyte that may otherwise be squeezed out of the liner or central element during compression. In some embodiments, a portion of a compressible liner or compressible central element may act as an electrolyte reservoir, and another portion remains free of electrolyte.

### Compressible Current Collectors

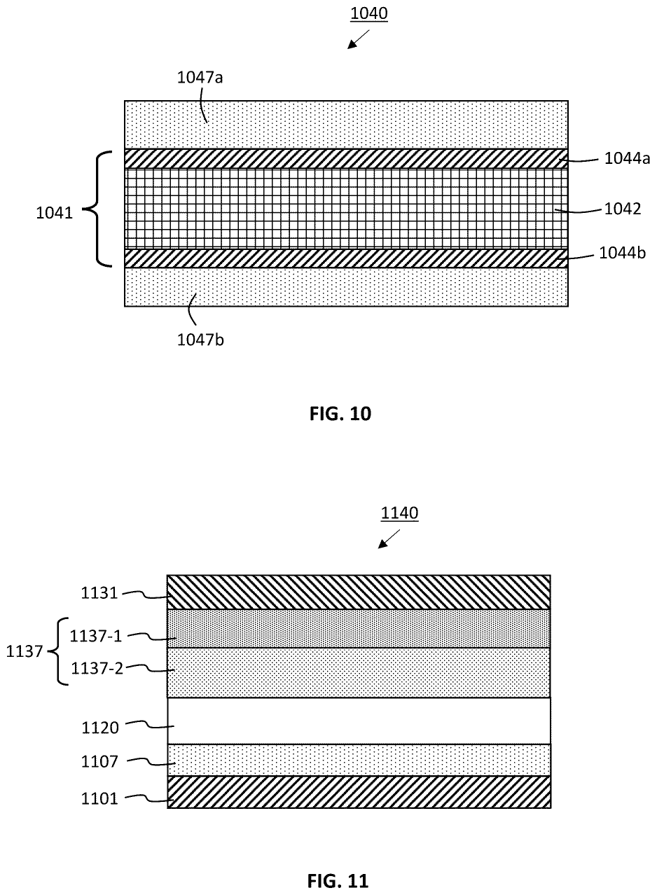

In some cases, one or both of the anode and cathode current collectors may have a compressible current collector structure, i.e., the current collector may be a compressible element. FIG. 10 is a cross-sectional schematic of an electrode having a compressible current collector according to some embodiments. Electrode 1040 may represent an anode or a cathode and includes a compressible current collector structure 1041 that may include a compressible core 1042, a first electrically conductive layer 1044a provided on the compressible core surface corresponding to a first side of the current collector, and a second electrically conductive layer 1044b provided on the compressible core surface corresponding to the second side of the current collector. A first active material layer 1047a may be provided on the first side of the current collector structure and a second active material layer 1047b may be provided on the second side of the current collector structure. Although not illustrated, the current collector may include a surface layer as discussed elsewhere.

Compressible core 1042 generally includes a structure and material that is substantially impervious to electrolyte, i.e., that does not readily absorb electrolyte or allow it in the structure. The compressible current collector structure may be substantially reversibly compressible, at least partially irreversibly compressible, or completely irreversibly compressible.

In some embodiments, compressible core 1042 is electrically insulating and may include a polymer. The polymeric compressible core may include a compressible polymeric material and/or may include a plurality of compressible internal pockets such as micro- or nano-pockets which may be void or include a gas, and preferably remain electrolyte-free. The internal pockets may be in the form of trapped bubbles. In some cases, a polymeric compressible core may be substantially reversibly compressible.

In some embodiments, compressible core 1042 is electrically conductive and may include a metal material having a plurality of micro- or nano-pockets which may be void or include a gas, and preferably remain electrolyte-free. The internal pockets may be in the form of trapped bubbles. In some cases, the conductive layer(s) may be formed of the same metal as the compressible core or alternatively from a different conductive material. In some cases, the conductive layers may not be distinct layers, but simply correspond to the first and second surfaces of the conductive compressible core. In some cases, metallic compressible cores are not reversibly compressible.

In some cases, a compressible current collector may have the appearance of a foam in cross section.

In some embodiments, the conductive layers may have lower compressibility than the compressible core, which may promote structural integrity of the active material/current collector interface.

### Compressible Active Material Layers

When active material layers are coated from a slurry or the like, it is common to calender (roll under pressure) the active material layer. This compresses the layer to promote better electrical conductivity through the layer (e.g., by improved packing of conductive carbon-based materials that are often added to the active material) and may also increase the cohesion of the active material layer or adhesion to the current collector. In the present disclosure, one or both cathode active material layers may be coated from a slurry. Similarly, one of the silicon-containing anode active material layers may be slurry coated.

In some embodiments, rather than optimally calendering an active material layer prior to battery assembly, there may be no or limited calendering so that the active material layer is sufficiently functional in the cell, but still compressible. Upon cycling and expansion of the silicon, in particular a silicon-containing anode active material layer deposited by a CVD or PVD process, the internal cell pressures may at least in part be absorbed by the compressible slurry coated active material layers. This may further “in situ” calender the active material layer so that after initial cycling it may have improved properties (e.g., lower resistance) relative as originally provided in the cell. The battery cell may optionally include an electrolyte reservoir.

In some cases, a slurry-coated active material layer (e.g., a cathode active material layer) in the battery cell may be a compressible element. Although an active material layer may be reversibly compressible, in many cases, it is partially or substantially irreversibly compressible.

In a non-limiting example, a cathode active material layer that is normally calendered to a density of 3.7 g/cm³ and a thickness of 92 microns, may be replaced by a high porosity, low-density cathode active material that has been calendered to only 120 microns and has a density of just 2.8 g/cm³. The conventional cathode material layer thickness and density may have the desired performance properties for operational use, but the low-density cathode is functional. If during initial charging of a 14-micron Si-containing anode active material layer causes it to expand to 42 microns (delta of 28 microns) that pressure may be transferred and applied to the low-density cathode active material layer and compress it by 28 microns to the desired thickness and density (92 microns and 3.7 g/cm³). In this non-limiting example, the separator may have relatively low compressibility, e.g., a ceramic-based separator, to ensure significant transfer of compressive force to the low-density cathode. Similarly, the current collectors may be chosen to have low compressibility. However, other embodiments may start with a cathode that is intermediate in density and does not require as much compression to achieve the desired operational thickness and density. In such cases, the separator(s) or current collector(s) may have some compressibility.

In some embodiments, a cathode active material layer may initially have a multilayer structure. FIG. 11 is a cross-sectional schematic of a portion of a battery cell 1140 having a compressible cathode active material layer according to some embodiments. A separator 1120 is disposed between a silicon-containing active material layer 1107 (provided on one side of anode current collector 1101) and a compressible cathode active material layer 1137 (provided on one side of cathode current collector 1131). Compressible active cathode material layer 1137 may include a first sublayer 1137-1 adjacent to the cathode current collector 1131 and a second sublayer 1137-2 disposed toward the anode, e.g., adjacent to the separator 1120 in FIG. 11. Sublayer 1137-2 may have a lower density than 1137-1. For example, sublayer 1137-1 may be first coated from a first cathode formulation onto the cathode current collector and calendered to a desired thickness. Sublayer 1137-2 may be coated from a second cathode formulation onto the first sublayer 1137-1. In some cases, the second sublayer 1137-2 is not calendered or receives less calendering pressure than sublayer 1137-1. In some cases, the second cathode formulation may be the same as the first cathode formulation, but alternatively, it may be different. For example, the second cathode formulation may have a higher ratio of binder to cathode active material. Alternatively, or in addition, the second cathode formulation may use a different binder, or a different amount or type of conductive agent. During electrochemical cycling, e.g., during a charging event, the second cathode material sublayer 1137-2 may be a compressed (act as a compressible element) more than sublayer 1137-1. Relative to a single low-density compressible cathode active material layer which may have initial resistance or other issues, having sublayer 1137-1 may provide improved initial cell performance to allow for an effective charging event that can compress the second sublayer. Not only does this at least partially allow for expansion of the silicon anode, the compression places the cathode in a more effective structural state (higher density and/or higher conductivity) after the compression.

Although not mentioned in the sections relating to separators and liners, a similar strategy may be optionally employed for any of these materials that may be calendered before use or sale (including but not necessarily limited to cellulose). That is, in such cases, they may instead by in situ calendered by expansion forces during charging of the anode.

### Solid-State Cells

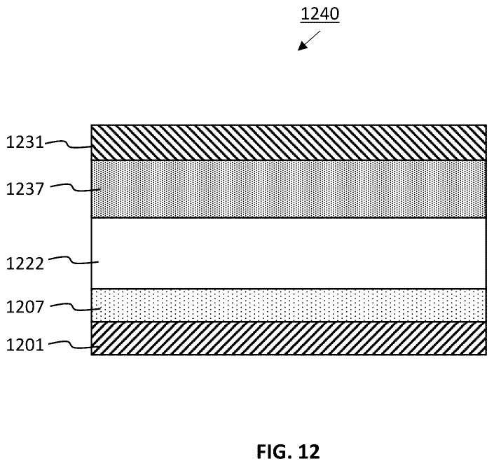

Just as the present disclosure pertains to battery cells with liquid nonaqueous electrolyte and separators, many of the expansion mitigation measures disclosed herein can be applied to solid-state batteries. FIG. 12 is a cross-sectional schematic of a portion of a solid-state battery cell 1240 according to various embodiments. Solid-state battery cell 1240 may include a solid-state electrolyte (“SSE”) layer 1222 disposed between a silicon-containing active material layer 1207 (provided on one side of anode current collector 1201) and a cathode active material layer 1237 (provided on one side of cathode current collector 1231). In some embodiments, one or more of these features may act as a compressible element. For example, the SSE layer may be a compressible SSE layer. Alternatively, or in addition, one or both current collectors may be a compressible current collector. Alternatively, or in addition, the cathode active material layer may be a compressible cathode active material layer.

### Electrochemical Pretreatment

Before use, the battery assembly in the cell housing typically undergoes one or more electrochemical cycling formation steps. “Electrochemical formation” (or sometimes referred to in the art simply as “formation”) is an electrochemical process whereby a voltage is applied and varied between the anode and cathode to cause the cell to charge and discharge one or more times. This establishes an SEI coating on the anode and a cathode-electrolyte interphase (“CEI”) coating on the cathode, and is associated with some initial (often irreversible) charge capacity losses (sometimes called “formation loss”) that stabilize with a few formation cycles. This often places the cell in a more reliable starting position for actual use. Electrochemical formation on silicon-dominant anodes can sometimes result in large expansion, whereas expansion in actual operation may be much smaller. This can place a large burden on the cell design to handle such expansion for the electrochemical formation step.

In some embodiments, the anode and cathode, or alternatively just the anode, may undergo an electrochemical pretreatment prior to their assembly into a final battery cell. The electrochemical pretreatment may in some cases be similar to electrochemical formation cycling protocols, but which are performed in a temporary cell in the presence of a pretreatment electrolyte (which may have a composition that is the same or different from the electrolyte used in the final battery cell). In some cases, an electrochemical pretreatment causes at least a partial charging of the anode and may subsequently include at least a partial discharge. For example, a jelly roll electrode assembly may be loosely wound and placed in an oversized temporary cell and a pretreatment electrolyte. The electrode assembly may be provided with an electrochemical pretreatment and the temporary cell can readily accommodate expansion and other dimensional changes. Next, the pretreated jelly roll assembly can be transferred to the final cell for final battery construction. The pretreated jelly roll assembly may optionally be rinsed, dried, have its winding tightened, or provided with some other intermediate treatment before transfer to the final cell casing. In the final cell, the expansion of the anode during operational charging may undergo substantially less expansion than the expansion during electrochemical pretreatment, e.g., in a range of 20-30% less, 30-40% less, 40-50% less, 50-60% less, 60-70% less, or any combination of ranges thereof, or even more than 70% less. Expansion may in some cases refer to any dimensional distortion of the anode, e.g., the expansion of the anode active material layer, wrinkling of the anode current collector, or the like.

In some embodiments, the anode or the anode and cathode may simply be drawn through an electrolyte bath, with appropriate counter electrodes if necessary, and electrochemically pretreated. The pretreated electrode(s) may then be wound or cut and transferred to a battery cell casing.

Electrochemical pretreatments may be carried at ambient temperature (~20° C.) or at some temperature(s) above or below ambient. In some embodiments, electrochemical pretreatments may be conducted at a temperature of 0-10° C., 10-20° C., 20-30° C., 30-40° C., 40-50° C., 50-60° C., 60-70° C., 70-80° C., 80-90° C., 90-100° C., or any combination of ranges thereof, or even higher than 100° C.

In some embodiments, an electrochemically pretreated anode or both the anode and cathode may be subjected to calendering.

### Electrolyte

The nonaqueous lithium-ion electrolyte may be a liquid, a solid, or a gel, or some multi-phase combination. A typical liquid electrolyte includes one or more solvents and one or more salts, at least one of which includes lithium. During the first few charge cycles (sometimes referred to as formation cycles), the organic solvent and/or the electrolyte may partially decompose on the negative electrode surface to form an SEI (Solid-Electrolyte-Interphase) layer. The SEI is generally electrically insulating but ionically conductive, thereby allowing lithium ions to pass through. The SEI may lessen decomposition of the electrolyte in the later charging cycles.

Some non-limiting examples of non-aqueous solvents suitable for some lithium ion cells include the following: cyclic carbonates (e.g., ethylene carbonate (EC), fluoroethylene carbonate (FEC), propylene carbonate (PC), butylene carbonate (BC) and vinylethylene carbonate (VEC)), vinylene carbonate (VC), lactones (e.g., gamma-butyrolactone (GBL), gamma-valerolactone (GVL) and alpha-angelica lactone (AGL)), linear carbonates (e.g., dimethyl carbonate (DMC), methyl ethyl carbonate (MEC, also commonly abbreviated EMC), diethyl carbonate (DEC), methyl propyl carbonate (MPC), dipropyl carbonate (DPC), methyl butyl carbonate (MBC) and dibutyl carbonate (DBC)), ethers (e.g., tetrahydrofuran (THF), 2-methyltetrahydrofuran, 1,4-dioxane, 1,2-dimethoxyethane (DME), 1,2-diethoxyethane and 1,2-dibutoxyethane), nitriles (e.g., acetonitrile and adiponitrile) linear esters (e.g., methyl propionate, methyl pivalate, butyl pivalate and octyl pivalate), amides (e.g., dimethyl formamide), organic phosphates (e.g., trimethyl phosphate and trioctyl phosphate), organic compounds containing an S═O group (e.g., dimethyl sulfone and divinyl sulfone), and combinations thereof.

Non-aqueous liquid solvents can be employed in combination. Examples of these combinations include combinations of cyclic carbonate-linear carbonate, cyclic carbonate-lactone, cyclic carbonate-lactone-linear carbonate, cyclic carbonate-linear carbonate-lactone, cyclic carbonate-linear carbonate-ether, and cyclic carbonate-linear ester. In some embodiments, a cyclic carbonate may be combined with a linear ester. Moreover, a cyclic carbonate may be combined with a lactone and a linear ester. In some embodiments, the weight ratio, or alternatively the volume ratio, of a cyclic carbonate to a linear ester is in a range of 1:9 to 10:1, alternatively 2:8 to 7:3.

A salt for liquid electrolytes may include one or more of the following non-limiting examples: LiPF₆, LiBF₄, LiClO₄, LiAsF₆, LiN(CF₃SO₂)₂ (“LiTFSI”), LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), lithium salts having cyclic alkyl groups (e.g., (CF₂)₂(SO₂)₂ₓLi and (CF₂)₃(SO₂)₂ₓLi), LiFSI (lithium bis(fluorosulfonyl)imide), LiTDI (lithium 4,5-dicyano-2-(trifluoromethyl) imidazole), and combinations thereof.

In some embodiments, the total concentration of a lithium salt in a liquid non-aqueous solvent (or combination of solvents) is at least 0.3 M, alternatively at least 0.7M. The upper concentration limit may be driven by a solubility limit and operational temperature range. In some embodiments, the concentration of salt is no greater than about 2.5 M, alternatively no more than about 1.5 M. In some embodiments, the electrolyte may include a saturated solution of a lithium salt and excess solid lithium salt.

Additives may be included in the electrolyte to serve various functions such as to stabilize the battery. For example, additives such as polymerizable compounds having an unsaturated double bond may be added to stabilize or modify the SEI. Certain amines or borate compounds may act as cathode protection agents. Lewis acids can be added to stabilize fluorine-containing anion such as (PF₆)⁻. Safety protection agents include those to protect overcharge, e.g., anisoles, or act as fire retardants, e.g., alkyl phosphates. Other additives may include fluorinated materials such as FEC or various hydrofluoroethers, or silane or siloxane derivatives. Other additives may include ionic liquids or materials to scavenge or sequester water, HF, transition metal ions, or the like. In some embodiments, the electrolyte may be formulated as a localized high concentration electrolyte. In some embodiments, the electrolyte includes a non-aqueous ionic liquid and a lithium salt.

### SSE

The solid-state electrolyte includes a source of mobile lithium ions that diffuse between the anode and the cathode (to the anode during charging and away from the anode during discharging). The three main families of SSE are solid polymer electrolytes (SPEs), solid inorganic electrolytes (SIEs), and hybrid SSE which uses both SPE and SIE materials. Note that, herein, an SPE includes the category of gel electrolytes. In some cases, the source of lithium ion may include a lithium salt, which may be in the form of a small molecule (e.g., LiTSFI, LiPF₆ or some any other lithium salt described above) suspended or dissolved in a SSE matrix. In some cases, a SPE material may include an anionic functional group that may act as the lithium salt counterion. The SSE may optionally include plasticizers, rheology control agents, or even a small amount of organic solvent(s).

A few non-limiting examples of polymeric materials that may be used in the SSE composition include poly(ethylene oxide) (PEO), poly(acrylonitrile) (PAN), poly (methyl methacrylate) (PMMA), poly(vinyl alcohol) (PVA), poly (trimethylene carbonate), diester-based polymers, PVdF-based polymers, polycaprolactone, and their derivatives or copolymers, which may be used alone or in combination. The polymer of the SSE may in some cases be cross-linked or branched. The polymer may be a block copolymer. A polymer SSE may be fully amorphous or include some crystallinity. The polymer may include anionic functional groups.

A few non-limiting classes of SIE material that may be used in the SSE composition include b-aluminas, LISICONs, thio-LISICONs, NASICONs, perovskites, antiperovskites, garnets, complex hydrides, and solid sulfides.

A few non-limiting classes of solid sulfides include ceramic sulfides, glass sulfides, and glass-ceramic sulfides. Glass sulfides show minimal long-range order that is identified by the lack of peaks in the pattern resulting from x-ray diffraction (XRD) measurements. Glass-ceramic sulfides include some glass structural regions and some regions with long range order that is identified by characteristic peaks in the pattern resulting from XRD measurements. Ceramic sulfides, also known as crystalline sulfides, are composed of regions that have long range order that is identified by characteristic peaks in the pattern resulting from XRD measurements. Non-limiting examples of ceramic sulfides include argyrodites, silicon thiophosphates, and silicon halide thiophosphates. Exemplary, but non-limiting, solid sulfides comprise a thiophosphate (PS₄) that may be identified by a characteristic feature in the pattern resulting from measurement with either infrared spectroscopy or Raman spectroscopy. Some additional examples of solid sulfides may include Li₆PS₅Cl, LGPS materials such as Li₁₀GeP₂S₁₂, and LPS materials such as Li₇P₃S₁₁.

In some embodiments, under battery operating conditions, the SSE may have a lithium-ion conductivity in a range of 0.001 mS/cm to 0.01 mS/cm, alternatively in a range of 0.01 mS/cm to 0.1 mS/cm, alternatively in a range of 0.1 mS/cm to 1.0 mS/cm, alternatively higher than 1 mS/cm.

The thickness of the SSE should be sufficient to prevent shorting between the anode and cathode, but not so thick that it increases resistance or reduces energy density beyond desirable levels. An SSE generally has a thickness greater than 100 nm and less than 800 microns. For micro-batteries, it may be in a range of about 100 nm to 5 microns. For more conventional battery cells, the SSE may typically have a thickness in a range of 5-300 microns.

In some embodiments, an SSE may include a relatively small amount of organic solvent, e.g., for increasing lithium-ion conductivity or simply as a vehicle for adding lithium salts. Some non-limiting examples of such solvents include those listed above for liquid electrolytes. In some embodiments, the weight % of solvent relative to other components of the SSE may be less than 10%, alternatively less than 5%, 2%, 1%, 0.5%, 0.2%, or 0.1%.

In some embodiments, the SSE may be a compressible element (e.g., a compressible SSE layer).

In some embodiments, a battery cell may include a liquid electrolyte and an SSE layer (which may optionally be a compressible SSE layer) disposed on the cathode active material layer and/or on the silicon-containing anode active material layer. Such a battery cell may further include a separator.

### Cathode

Positive electrode (cathode) active materials for use in the cathode active material layer include, but are not limited to, lithium metal oxides or compounds (e.g., LiCoO₂, LiFePO₄, LiMnO₂, LiNiO₂, LiMn₂O₄, LiCoPO₄, LiNiₓCo_{y}Mn₂O₂, LiNi_{X}Co_{Y}Al_{Z}O₂, LiFe₂(SO₄)₃, or Li₂FeSiO₄), carbon fluoride, metal fluorides such as iron fluoride (FeF₃), metal oxide, sulfur, selenium and combinations thereof. Cathode active materials may operate, e.g., by intercalation, conversion, or a combination. Cathode active materials may be mixed with one or more binders and/or conductive agents (e.g., a conductive carbon) and coated to form the cathode active material layer. In some cases, the cathode active material layer may, in addition to a cathode active material, include polymeric, SIE, or hybrid SSE materials like any of those described elsewhere, and which may be the same as or different than the material used in an SSE layer between the anode and cathode. In some cases, a solid electrolyte used in the cathode may be different than the SSE layer. A cathode active material layer is typically provided on, or in electrical communication with, an electrically conductive cathode current collector.

### Electrochemical Formation

In some embodiments, the original, non-cycled anode may undergo structural or chemical changes during electrochemical charging/discharging, for example, from normal battery usage or from an earlier “electrochemical formation step”. As is known in the art, an electrochemical formation step is commonly used to form an initial SEI layer and sometimes involves relatively gentle conditions of low current and limited voltages. The modified anode prepared in part from such electrochemical charging/discharging cycles may still have excellent performance properties, despite such structural and/or chemical changes relative to the original, non-cycled anode. In some embodiments, the lithium storage layer of the cycled anode may no longer appear as a continuous layer, and instead, appear as separated segments or islands, generally with an average height-to-width aspect ratio of less than 2. While not being bound by theory, in the case of amorphous silicon, it may be that small amounts delaminate upon cycling at high stress areas. Alternatively, or in addition, it may be that structural changes upon lithiation and delithiation are not symmetrical, resulting in such islands or segments.

In some embodiments, a battery cell may be constructed with one or more ports. In some cases, the port may be used to transfer electrolyte into and/or out of the cell. For example, a cell may be equipped with one port that is used evacuate the cell and provide a low-pressure (vacuum) environment. This may be followed by injecting an electrolyte into the cell via the port. In some cases, there may be a separate port for electrolyte removal or “flushing” the cell with electrolyte via an injection port and a removal port. In some embodiments, electrochemical formation cycling may be done using a first electrolyte (a formation electrolyte) and then replaced with the nonaqueous lithium-ion electrolyte to be used in the operating cell. In some cases, electrochemical formation may be done at elevated temperatures, e.g., in a range of 40 to 100° C. In some cases, electrolyte filling and/or electrochemical formation may be performed at such elevated temperatures and the cell is sealed while still warm. This can create a small reduced-pressure environment which may also allow room for expansion during operation. That is, by starting the cell at a lower pressure, the pressure on the cell during expansion from lithiating the silicon will be less than it would have been had the cell started at ambient pressure.

In some embodiments, electrochemical cycling conditions of a battery cell in operation may be set to utilize only a portion of the theoretical charge/discharge capacity of silicon (3600 mAh/g). In some embodiments, electrochemical charging/discharging cycles may be set to utilize 400-600 mAh/g, alternatively 600-800 mAh/g, alternatively 800-1000 mAh/g, alternatively 1000-1200 mAh/g, alternatively 1200-1400 mAh/g, alternatively 1400-1600 mAh/g, alternatively 1600-1800 mAh/g, alternatively 1800-2000 mAh/g, alternatively 2000-2200 mAh/g, alternatively 2200-2400 mAh/g, alternatively 2400-2600 mAh/g, alternatively 2600-2800 mAh/g, alternatively 2800-3000 mAh/g, alternatively 3000-3200 mAh/g, alternatively 3200-3400 mAh/g, or any combination of ranges thereof.

In some embodiments, battery cells of the present disclosure may have a volumetric density of at least 750 Wh/L, e.g., 750-800 Wh/L, 800-900 Wh/L, 900-1000 Wh/L, or any combination of ranges thereof, or even higher than 1000 Wh/L. In some embodiments, battery cells of the present disclosure may have a gravimetric density of at least 300 Wh/kg, e.g., 300-350 Wh/kg, 350-400 Wh/kg, 400-500 Wh/kg, 500-600 Wh/kg, 600-700 Wh/kg, or any combination of ranges thereof, or even higher than 700 Wh/kg. In some embodiments, battery cells of the present disclosure may be characterized by an 80% SoH (state-of-health) cycle life of greater than 150 cycles, or optionally greater than 200 cycles, or optionally greater than 300 cycles, when tested at a discharge rate of C/3 and a charge rate of C/3, or optionally at a charge rate of 1 C, or optionally at a charge rate of 3 C.

### N/P Ratio

A battery cell may be characterized by its “N/P ratio” which is a ratio of the charge capacity per unit area of anode (negative) active material relative to the charge capacity per unit area of the cathode (positive) active material. In some embodiments, the N/P ratio is in a range of 0.95-1.0, alternatively 1.0-1.05, 1.05-1.1, 1.1-1.2, 1.2-1.3, 1.3-1.4, 1.4-1.5, 1.5-1.6, 1.6-1.7, 1.7-1.8, 1.8-1.9, 1.9-2.0, 2.0-2.5, 2.5-3.0, 3.0-3.5, 3.5-4.0, or any combination of ranges thereof, or even higher than 4.0. In some cases, the N/P ratio is at least 1.05.

In a non-limiting example, a battery cell may include: a) an anode having copper foil current collector (10-14 μm) and PECVD-deposited silicon on both sides (10-16 μm): b) a compressible separator (25-35 μm) that is compressible by 40-60%, and c) a cathode having an aluminum current collector (8-15 μm) and cathode active material coated on both sides (85-100 μm).

In some embodiments, using one or more of the expansion-mitigating technologies disclosed above (compressible separator, compressible cathode active material layer, compressible current collector, compressible central element, compressible liner, electrolyte reservoirs, higher porosity silicon-containing anode active material, electrochemical pretreatment, etc.) may reduce pressures on a cell casing caused by anode expansion (e.g., during charging or formation) by at least 25%, alternatively by at least 50%, alternatively by at least 75%, relative to the same cell without any of the expansion-mitigating technologies. In some embodiments, using one or more expansion-mitigation technologies may allow electrode assembly swell during charging to be less than 10% of initial electrode assembly thickness (or subunit thickness), alternatively less than 8%, alternatively less than 5%.

### System Considerations

In some cases, the battery cell may include one or more pressure elements to apply some moderate physical pressure between anode and cathode which may help the overall structural stability of the electrode assembly during cycling. For example, in the case of solid-state batteries, the anode or cathode may be prone to disconnect from the SSE during a discharge cycle and an external force may maintain good connection. Pressure elements may be compressible films, e.g., made from a porous polymer or silicone. In some cases, a compressible liner used between the electrode assembly and the housing may also act as a pressure element. Alternatively, the pressure element may include a spring or an array of springs. Alternatively, pressure members may correspond to two sides of a compression clip or clamp.

In some embodiments, a plurality of battery cells may be used together in a battery module. In the case of prismatic lithium-ion battery cells, some bowing may occur during operation. As a precaution, compressible pads may be placed between prismatic cells so that bowing/expansion forces do not propagate through the module. In some cases, the expansion mitigation technology disclosed herein may reduce or eliminate the need for such compressible pads between battery cells.

### ENUMERATED EMBODIMENTS

Still further embodiments herein include the following enumerated embodiments.

Enumerated embodiment 1. A lithium-ion battery cell including:
an electrode assembly including:
   a) an anode including an anode current collector and a first silicon-containing anode active material layer disposed on a first side of the anode current collector, wherein the first silicon-containing anode active material layer includes at least 85 atomic % silicon;
   b) a cathode including a cathode current collector and a first cathode active material layer disposed on a first side of the cathode current collector, wherein the first side of the cathode current collector is proximal to the first side of the anode current collector; and
   c) a first separator disposed between the first cathode active material layer and the first anode active material layer;
a nonaqueous lithium-ion electrolyte disposed between, and in contact with, the anode and cathode; and
a battery cell housing containing the electrode assembly and the nonaqueous lithium-ion electrolyte, wherein the housing includes a positive battery terminal in electrical communication with the cathode and a negative battery terminal in electrical communication with the anode.

Enumerated embodiment 2. The battery cell of enumerated embodiment 1, wherein:
the anode includes a second silicon-containing anode active material layer disposed on a second side of the anode current collector; and
the cathode includes a second cathode active material layer disposed on a second side of the cathode current collector, wherein the second side of the cathode current collector is distal to the first side of the anode current collector.

Enumerated embodiment 3. The lithium-ion battery cell of enumerated embodiment 2, wherein the electrode assembly further includes a second separator disposed between the second cathode active material layer and i) the second silicon-containing anode active material layer when the electrode assembly includes a jellyroll structure, or ii) a silicon-containing anode active material provided on a second anode current collector when the electrode assembly includes a stacked structure.

Enumerated embodiment 4. The battery cell of enumerated embodiment 2, wherein the electrode assembly further includes a second separator, wherein the cathode is disposed between the first separator and the second separator.

Enumerated embodiment 5. The battery cell of enumerated embodiment 4, wherein the electrode assembly includes a jellyroll structure or a stacked structure.

Enumerated embodiment 6. The battery cell according to any of enumerated embodiments 3-5, wherein:
in a cross section, the anode, first separator, cathode, and second separator form a first subunit of the electrode assembly,
the first subunit is a subunit in a plurality of subunits, each subunit including a respective anode, a respective first separator, a respective cathode, and a respective second separator, and
the plurality of subunits is arranged as a stacked structure or as a jellyroll structure.

Enumerated embodiment 7. The lithium-ion battery cell of enumerated embodiment 6, wherein the plurality of subunits includes at least 5 subunits.

Enumerated embodiment 8. The battery cell according to any of enumerated embodiments 1-7, wherein at least one silicon-containing anode active material layer is characterized by a silicon loading in a range of 1 to 4 mg/cm².

Enumerated embodiment 9. The battery cell according to any of enumerated embodiments 1-8, wherein prior to assembling the cell, at least one silicon-containing anode active material layer is characterized by an as-deposited density in a range of 1.2 to 2.2 g/cm³.

Enumerated embodiment 10. The battery cell according to any of enumerated embodiments 1-9, wherein at least one silicon-containing active material layer is characterized by a density in a range of 1.2 to 2.2 g/cm³.

Enumerated embodiment 11. The battery cell according to any of enumerated embodiments 1-10, wherein prior to assembling the cell, at least one silicon-containing anode active material layer is characterized by an as-deposited thickness in a range of 3 to 25 μm.

Enumerated embodiment 12. The battery cell according to any of enumerated embodiments 1-11, wherein at least one silicon-containing anode active material layer is characterized by a thickness in a range of 3 to 25 μm.

Enumerated embodiment 13. The battery cell according to any of enumerated embodiments 1-12, wherein at least one separator includes a compressible material.

Enumerated embodiment 14. The battery cell according to any of enumerated embodiments 1-13, wherein during battery cell operation, at least one separator is compressible from an initial thickness by at least 25%, or optionally by at least 50%.

Enumerated embodiment 15. The battery cell of enumerated embodiment 13 or 14, wherein the at least one separator is substantially reversibly compressible.

Enumerated embodiment 16. The battery cell of enumerated embodiment 13 or 14, wherein the at least one separator is at least partially irreversibly compressible.

Enumerated embodiment 17. The battery cell of enumerated embodiment 16, wherein the at least one separator includes a cellulose-based material.

Enumerated embodiment 18. The battery cell according to any of enumerated embodiments 1-17, wherein at least one separator includes a multilayer structure including an anode-facing side and a cathode-facing side.

Enumerated embodiment 19. The battery cell of enumerated embodiment 18, wherein the anode-facing side is more compressible than the cathode-facing side.

Enumerated embodiment 20. The battery cell of enumerated embodiment 18 or 19, wherein the anode-facing side includes a cellulose-based material or a synthetic polymer, and the cathode-facing side includes a ceramic material or a synthetic polymer.

Enumerated embodiment 21. The battery cell of enumerated embodiment 18, wherein the anode-facing side is less compressible than the cathode-facing side.

Enumerated embodiment 22. The battery cell of enumerated embodiment 18 or 19, wherein the anode-facing side includes a ceramic material or a synthetic polymer, and the cathode-facing side includes a cellulose-based material or a synthetic polymer.

Enumerated embodiment 23. The battery cell according to any of enumerated embodiments 1-22, further including an electrolyte reservoir, wherein the electrolyte reservoir is in fluid communication with the electrolyte disposed between the anode and the cathode.

Enumerated embodiment 24. The battery cell of enumerated embodiment 23, wherein the battery cell is configured such that during battery cell operation, electrolyte is flowable to and from the electrolyte reservoir.

Enumerated embodiment 25. The battery cell of enumerated embodiment 23 or 24, wherein the battery cell is characterized by an internal volume and the electrolyte reservoir occupies a reservoir volume that is in a range of 5% to 15% of the internal volume.

Enumerated embodiment 26. The battery cell according to any of enumerated embodiments 1-25, wherein at least one separator includes a material that scavenges or binds HF or water.

Enumerated embodiment 27. The battery cell according to any of enumerated embodiments 1-26, wherein at least one current collector includes a compressible current collector structure.

Enumerated embodiment 28. The battery cell of enumerated embodiment 27, wherein the compressible current collector structure includes a compressible core, a first electrically conductive layer provided on the compressible core corresponding to the first side of the current collector, and a second electrically conductive layer provided on the compressible core corresponding to the second side of the current collector.

Enumerated embodiment 29. The battery cell of enumerated embodiment 28, wherein the compressible core includes a polymer.

Enumerated embodiment 30. The battery cell of enumerated embodiment 28 or 29, wherein the compressible core defines internal bubbles or voids.

Enumerated embodiment 31. The battery cell according to any of enumerated embodiments 28-30, wherein the compressible core is electrically insulating.

Enumerated embodiment 32. The battery cell according to any of enumerated embodiments 28-30, wherein the compressible core is electrically conductive.

Enumerated embodiment 33. The battery cell according to any of enumerated embodiments 28-32, wherein the current collector structure is substantially impervious to electrolyte.

Enumerated embodiment 34. The battery cell according to any of enumerated embodiments 27-33, wherein the current collector structure is substantially reversibly compressible.

Enumerated embodiment 35. The battery cell according to any of enumerated embodiments 27-33, wherein the current collector structure is at least partially irreversibly compressible.

Enumerated embodiment 36. The battery cell according to any of enumerated embodiments 27-35, wherein the current collector structure is compressible from an initial thickness by at least 10%, or optionally by at least 20%, or optionally by at least 30%, or optionally by at least 40%.

Enumerated embodiment 37. The battery cell according to any of enumerated embodiments 27-36, wherein the anode current collector includes the compressible structure, and the cathode current collector is incompressible.

Enumerated embodiment 38. The battery cell according to any of enumerated embodiments 27-36, wherein the cathode current collector includes the compressible structure, and the anode current collector is incompressible.

Enumerated embodiment 39. The battery cell according to any of enumerated embodiments 27-36, wherein the anode current collector and the cathode current collector each include an individually selected compressible current collector structure.

Enumerated embodiment 40. The battery cell according to any of enumerated embodiments 1-39, wherein at least one cathode active material layer is compressible.

Enumerated embodiment 41. The battery cell of enumerated embodiment 34, wherein during at least one electrochemical cycle, the at least one cathode active material layer is compressible to less than 90% of its original thickness, or optionally to less than 80% of its original thickness or optionally less than 70% of its original thickness.

Enumerated embodiment 42. The battery cell of enumerated embodiment 40 or 41, wherein the at least one cathode active material layer is substantially reversibly compressible.

Enumerated embodiment 43. The battery cell of enumerated embodiment 40 or 41, wherein the at least one cathode active material layer is at least partially irreversibly compressible.

Enumerated embodiment 44. The battery cell according to any of enumerated embodiments 2-43, wherein the first cathode active material layer and the second cathode active layer are compressible.

Enumerated embodiment 45. The battery cell according to any of enumerated embodiments 2-44, wherein the first cathode active material layer and the second cathode active layer each have an independently selected thickness in a range of 40 to 200 μm prior to any electrochemical cycling.

Enumerated embodiment 46. The battery cell according to any of enumerated embodiments 2-45, wherein the first cathode active material layer is different than the second cathode active layer with respect to thickness, chemical composition, or both thickness and chemical composition.

Enumerated embodiment 47. The battery cell according to any of enumerated embodiments 2-46, wherein the first cathode active material layer is substantially the same as the second cathode active material layer.

Enumerated embodiment 48. The battery cell according to any of enumerated embodiments 2-47, wherein the first cathode active material layer and the second cathode active layer each include a lithium metal oxide compound.

Enumerated embodiment 49. The battery cell according to any of enumerated embodiments 2-47, wherein the first cathode active material layer and the second cathode active layer each include sulfur, selenium, or both sulfur and selenium.

Enumerated embodiment 50. The battery cell according to any of enumerated embodiments 1-49, wherein at least one silicon-containing anode active material layer is substantially free of high aspect ratio lithium storage nanostructures.

Enumerated embodiment 51. The battery cell according to any of enumerated embodiments 1-50, wherein at least one silicon-containing anode active material layer is a continuous porous lithium storage layer.

Enumerated embodiment 52. The battery cell according to any of enumerated embodiments 1-51, wherein at least one silicon-containing anode active material layer includes a sub-stoichiometric nitride of silicon.

Enumerated embodiment 53. The battery cell according to any of enumerated embodiments 1-52, wherein at least one silicon-containing anode active material layer includes a sub-stoichiometric oxide of silicon.

Enumerated embodiment 54. The battery cell according to any of enumerated embodiments 1-53, wherein at least one silicon-containing anode active material layer includes amorphous silicon.

Enumerated embodiment 55. The battery cell according to any of enumerated embodiments 1-54 wherein at least one silicon-containing anode active material layer includes less than 30% of nano-crystalline silicon.

Enumerated embodiment 56. The battery cell according to any of enumerated embodiments 1-55, wherein the at least one silicon-containing anode active material layer includes columns of silicon nanoparticle aggregates.

Enumerated embodiment 57. The battery cell according to any of enumerated embodiments 1-56, wherein at least one silicon-containing anode active material layer is deposited by a PVD or CVD process.

Enumerated embodiment 58. The battery cell of enumerated embodiment 57, wherein the at least one silicon-containing anode active material layer is deposited by PECVD.

Enumerated embodiment 59. The battery cell according to any of enumerated embodiments 1-58, wherein at least one silicon-containing anode active material layer is substantially free of carbon-based binders.

Enumerated embodiment 60. The battery cell according to any of enumerated embodiments 1-49, wherein at least one silicon-containing anode active material layer includes silicon-containing nanowires.

Enumerated embodiment 61. The battery cell according to any of enumerated embodiments 2-60 wherein the second silicon-containing anode active material layer includes at least 85 atomic % silicon and is optionally deposited by a PVD or CVD process.

Enumerated embodiment 62. The battery cell according to any of enumerated embodiments 2-61, wherein the second silicon-containing anode active material layer is substantially the same as the first silicon-containing anode active material layer with respect to thickness, chemical composition, or areal capacity, or any combination thereof.

Enumerated embodiment 63. The battery cell according to any of enumerated embodiments 2-61, wherein the second silicon-containing anode active material layer is different from the first silicon-containing anode active material layer with respect to thickness, chemical composition, or areal capacity, or any combination thereof.

Enumerated embodiment 64. The battery cell according to any of enumerated embodiments 2-63, wherein the second silicon-containing anode active material layer is a continuous porous lithium storage layer.

Enumerated embodiment 65. The battery cell according to any of enumerated embodiments 2-64, wherein the second silicon-containing anode active material layer includes amorphous silicon.

Enumerated embodiment 66. The battery cell according to any of enumerated embodiments 2-65, wherein the second silicon-containing anode active material layer includes less than 30% of nano-crystalline silicon.

Enumerated embodiment 67. The battery cell according to any of enumerated embodiments 2-66, wherein the second silicon-containing anode active material layer includes columns of silicon nanoparticle aggregates.

Enumerated embodiment 68. The battery cell according to any of enumerated embodiments 2-67, wherein the second silicon-containing anode active material layer is deposited by PECVD.

Enumerated embodiment 69. The battery cell according to any of enumerated embodiments 2-61, wherein the second silicon-containing anode active material layer includes silicon-containing nanowires or microwires.

Enumerated embodiment 70. The battery cell according to any of enumerated embodiments 2-60, wherein the second silicon-containing anode active material layer includes silicon-containing particles dispersed in a binder.

Enumerated embodiment 71. The battery cell of enumerated embodiment 70, wherein the second silicon-containing anode active material layer includes at least 10% by weight of silicon.

Enumerated embodiment 72. The battery cell according to any of enumerated embodiments 1-71, further characterized by a volumetric energy density of at least 800 Wh/L.

Enumerated embodiment 73. The battery cell according to any of enumerated embodiments 1-72, further characterized by a gravimetric energy density of at least 400 Wh/kg.

Enumerated embodiment 74. The battery cell according to any of enumerated embodiments 1-73, characterized by an 80% state-of-health (SoH) cycle life of greater than 150 cycles, or optionally greater than 200 cycles, or optionally greater than 300 cycles, when tested at a discharge rate of C/3 and a charge rate of C/3, or optionally at a charge rate of 1 C, or optionally at a charge rate of 3 C.

Enumerated embodiment 75. The battery cell according to any of enumerated embodiments 1-74, further characterized by an N/P ratio in a range of 1.05 to 4.0, or optionally 1.1 to 2.0.

Enumerated embodiment 76. The battery cell according to any of enumerated embodiments 2-75, wherein the electrode assembly includes a plurality of anodes and a plurality of cathodes in a stacked structure, and wherein a respective separator is disposed between each pair of anode and cathode.

Enumerated embodiment 77. The battery cell of enumerated embodiment 76, wherein the first and second separators are portions of a single continuous separator folded between adjacent anodes and cathodes.

Enumerated embodiment 78. The battery cell of enumerated embodiment 76 or 70, further including a compressible liner disposed between at least a portion of the housing and the electrode assembly.

Enumerated embodiment 79. The battery cell of enumerated embodiment 78, wherein the compressible liner includes an electrically insulating polymer.

Enumerated embodiment 80. The battery cell of enumerated embodiment 78 or 79, wherein the compressible liner defines internal bubbles or voids.

Enumerated embodiment 81. The battery cell according to any of enumerated embodiments 78-80, wherein the compressible liner is reversibly compressible.

Enumerated embodiment 82. The battery cell according to any of enumerated embodiments 78-80, wherein the compressible liner is at least partially irreversibly compressible.

Enumerated embodiment 83. The battery cell of enumerated embodiments 76-82, wherein the cell is a pouch cell and the housing includes a flexible polymer material.

Enumerated embodiment 84. The battery cell of enumerated embodiment 83, wherein the housing includes an aluminum-polymer laminate having a thickness of less than 0.2 mm.

Enumerated embodiment 85. The battery cell of enumerated embodiments 76-72, wherein the cell is a prismatic cell and the housing includes a rigid material.

Enumerated embodiment 86. The battery cell of enumerated embodiment 85, wherein the housing includes a metal having a thickness of at least 0.2 mm.

Enumerated embodiment 87. The battery cell of enumerated embodiment 85 or 86, wherein the housing includes aluminum or stainless steel.

Enumerated embodiment 88. The battery cell according to any of enumerated embodiments 2-75, wherein the housing includes a rigid material, and wherein the anode, the first separator, cathode, and the second separator are wound to form a jellyroll structure positioned inside the housing.

Enumerated embodiment 89. The battery cell of enumerated embodiment 88, further including a central element around which the jellyroll structure is wound.

Enumerated embodiment 90. The battery cell of enumerated embodiment 89, wherein the central element includes a compressible material.

Enumerated embodiment 91. The battery cell of enumerated embodiment 89 or 90, further including an inner compressible liner disposed between at least a portion of the central element and the jellyroll structure.

Enumerated embodiment 92. The battery cell according to any of enumerated embodiments 88-91, further including an outer compressible liner disposed between at least a portion of the housing and the jellyroll structure.

Enumerated embodiment 93. The battery cell of enumerated embodiment 92, wherein the compressible liner includes an electrically insulating polymer.

Enumerated embodiment 94. The battery cell of enumerated embodiment 92 or 93, wherein the compressible liner defines internal bubbles or voids.

Enumerated embodiment 95. The battery cell according to any of enumerated embodiments 92-94, wherein the compressible liner is reversibly compressible.

Enumerated embodiment 96. The battery cell according to any of enumerated embodiments 92-94, wherein the compressible liner is partially irreversibly compressible or completely irreversibly compressible.

Enumerated embodiment 97. The battery cell according to any of enumerated embodiments 88-96, wherein the housing includes a cylindrical casing, a top cap, a base opposite the top cap, and an electrically insulating seal separating the top cap from the cylindrical casing.

Enumerated embodiment 98. The battery cell of enumerated embodiment 97, wherein i) the top cap includes the positive battery terminal such that the top cap is in electrical communication with the cathode, and ii) the base includes the negative battery terminal such that the base is in electrical communication with the anode.

Enumerated embodiment 99. The battery cell of enumerated embodiment 98, wherein the cathode is in electrical communication with the top cap via i) a cathode tab element in electrical contact with the cathode current collector, or ii) an edge area of the cathode current collector that is free of cathode active material.

Enumerated embodiment 100. The battery cell of enumerated embodiment 98 or 99, wherein the anode is in electrical communication with the base via i) one or more anode tab elements in electrical contact with the anode current collector, or ii) an edge area of the anode current collector that is free of anode active material.

Enumerated embodiment 101. The battery cell of enumerated embodiment 97, wherein i) the top cap includes the negative battery terminal such that the top cap is in electrical communication with the anode, and ii) the base includes the positive battery terminal such that the base is in electrical communication with the cathode.

Enumerated embodiment 102. The battery cell of enumerated embodiment 101, wherein the anode is in electrical communication with the top cap via i) an anode tab element in electrical contact with the anode current collector, or ii) an edge area of the anode current collector that is free of anode active material.

Enumerated embodiment 103. The battery cell of enumerated embodiment 101 or 102, wherein the cathode is in electrical communication with the base by i) one or more cathode tab elements in electrical contact with the cathode current collector, or ii) an edge area of the cathode current collector that is free of cathode active material.

Enumerated embodiment 104. The battery cell according to any of enumerated embodiments 98-103, wherein electrical communication with the anode or with the cathode is made in part by a laser weld, a resistance weld, or ultrasonic weld.

Enumerated embodiment 105. The battery cell according to any of enumerated embodiments 88-104, wherein the battery cell is a cylindrical cell.

Enumerated embodiment 106. The battery cell of according to any of enumerated embodiments 88-96, wherein the housing includes a rectangular casing, a top lid, and a base opposite the top lid, and wherein the jellyroll structure has an oblong shape.

Enumerated embodiment 107. The battery cell of enumerated embodiment 106, wherein the top lid includes the positive battery terminal and the negative battery terminal.

Enumerated embodiment 108. The battery cell of enumerated embodiment 107, wherein the positive battery terminal is in electrical communication with the cathode current collector via a cathode tab element and the negative battery terminal is in electrical communication with the anode current collector via an anode tab element.

Enumerated embodiment 109. The battery cell according to any of enumerated embodiments 88-96 or 106-108, wherein the battery cell is characterized as a prismatic cell.

Enumerated embodiment 110. The battery cell according to any of enumerated embodiments 88-109, wherein the jellyroll structure or a portion thereof is characterized by a radius of curvature, and wherein a thickness of the at least one silicon-containing active anode material layer is less than 1% of the radius of curvature.

Enumerated embodiment 111. The battery cell according to any of enumerated embodiments 88-110, wherein a thickness of the at least one silicon-containing active anode material layer is at least 10% thinner at an inner portion of the jellyroll structure than at an outer portion of the jellyroll structure.

Enumerated embodiment 112. A method of making a battery cell, wherein the battery cell is one according to any of enumerated embodiments 88-111, the method including, prior to winding with the cathode, prelithiating the anode to form a prelithiated anode.

Enumerated embodiment 113. The method of enumerated embodiment 112, wherein the prelithiating includes contacting at least one silicon-containing anode active material layer with a non-aqueous lithium salt solution and applying a voltage bias between the anode current collector and a counter electrode, also in contact with the lithium salt solution, to thereby electrochemically reduce lithium ions and form the prelithiated anode.

Enumerated embodiment 114. The method of enumerated embodiment 112, wherein prelithiating includes contacting at least one silicon-containing anode active material layer with a reductive lithium organic compound or a stabilized lithium metal powder.

Enumerated embodiment 115. The method of enumerated embodiment 112, wherein the prelithiating includes contacting at least one silicon-containing anode active material layer with lithium metal.

Enumerated embodiment 116. The method of enumerated embodiment 115, further including depositing the lithium metal onto the at least one silicon-containing anode active material layer by PVD.

Enumerated embodiment 117. The method of enumerated embodiment 112, wherein at least one separator surface includes a lithium metal-containing layer, the method further including laminating the at least one separator to at least one silicon-containing anode active material layer with lithium metal-containing layer.

Enumerated embodiment 118. The method of enumerated embodiment 117, wherein the laminating further includes applying a pressure of at least 200 kPa.

Enumerated embodiment 119. The method according to any of enumerated embodiments 112-118, further including thermally treating the prelithiated anode by heating to a temperature of at least 50° C., or optionally to a temperature in a range of 50° C. to 150° C., for a period of at least 10 seconds, or optionally at least 1 minute.

Enumerated embodiment 120. The method of enumerated embodiment 119, wherein the thermally treating is performed before winding with the cathode.

Enumerated embodiment 121. The method of enumerated embodiment 119, wherein the thermally treating is performed after or while forming the jellyroll structure.

Enumerated embodiment 122. The method of according to any of enumerated embodiments 112-121, wherein at least one silicon-containing anode active material layer includes lithium in a range of 2% to 50% of the anode active material layer's lithium storage capacity.

Enumerated embodiment 123. A method of making a battery cell, wherein the battery cell is one according to any of enumerated embodiments 1-111, the method including contacting the anode and the cathode with a pretreatment electrolyte, applying a voltage bias between the anode current collector and the cathode current collector to cause at least one electrochemical cycle in the pretreatment electrolyte to produce a pretreated electrode structure, and contacting the pretreated electrode structure with the nonaqueous lithium-ion electrolyte.

Enumerated embodiment 124. The method of enumerated embodiment 123, further including transferring the pretreated electrode structure from an electrochemical pretreatment housing including the pretreatment electrolyte to the battery cell housing and adding the nonaqueous lithium-ion electrolyte.

Enumerated embodiment 125. The method of enumerated embodiment 123, further including placing the electrode assembly in the battery cell housing, adding the pretreatment electrolyte to the cell via an electrolyte injection port, removing at least some of the pretreatment electrolyte from the cell via an electrolyte removal port after producing the pretreated electrode structure, and adding the nonaqueous lithium-ion electrolyte to the cell through the electrolyte injection port.

Enumerated embodiment 126. The method of enumerated embodiment 125, wherein the electrolyte injection port and the electrolyte removal port are the same port.

Enumerated embodiment 127. The method according to any of enumerated embodiments 123-126, wherein the at least one electrochemical cycle in the pretreatment electrolyte is conducted at a temperature of at least 40° C., or optionally in a range of 40° C. to 100° C.

Enumerated embodiment 128. The method according to any of enumerated embodiments 123-127, further including, after contacting the pretreated electrode structure with the nonaqueous lithium-ion electrolyte, applying another voltage bias between the anode current collector and the cathode current collector to cause at least one electrochemical formation cycle in the nonaqueous lithium-ion electrolyte.

Enumerated embodiment 129. A method of making a battery cell, wherein the battery cell is one according to any of enumerated embodiments 1-111, the method including applying a voltage bias between the anode current collector and the cathode current collector to cause at least one electrochemical formation cycle in the nonaqueous lithium-ion electrolyte, wherein the nonaqueous lithium-ion electrolyte is at a temperature of at least 40° C., or optionally in a range of 40° C. to 100° C.

Enumerated embodiment 130. The method of enumerated embodiment 129, further including releasing gas through a vent in the battery cell housing during the at least one electrochemical formation cycle in the nonaqueous lithium-ion electrolyte.

Enumerated embodiment 131. The method of enumerated embodiment 130, further including closing the vent before allowing the nonaqueous lithium-ion electrolyte to cool below 40° C.

Enumerated embodiment 132. A method of making a battery cell, wherein the battery cell is one according to any of enumerated embodiments 1-111, the method including i) providing the battery cell in an unsealed state with the nonaqueous lithium-ion electrolyte at an elevated temperature of at least 40° C., or optionally in a range of 40° C. to 100° C., ii) sealing the battery cell, and iii) cooling the battery cell to below 40° C.

Enumerated embodiment 133. A method of making a battery cell, wherein the battery cell is one according to any of enumerated embodiments 1-111, the method including i) at ambient pressure, assembling the electrode assembly, ii) evacuating gas through a port on the battery cell housing so that the housing is under a state of partial vacuum, iii) partially filling the housing with the nonaqueous lithium-ion electrolyte, and iv) sealing the housing such that the housing has an internal pressure lower than ambient.

Enumerated embodiment 134. A method of making a battery cell, wherein the battery cell is one according to any of enumerated embodiments 1-111, the method including applying one or more electrochemical formation cycles to the battery cell, wherein at least one cathode active material layer is compressible, and wherein expansion of at least one silicon-containing anode active material reduces the thickness of the at least one cathode active material layer by at least 5%, or optionally by at least 10%.

Enumerated embodiment 135. The method of enumerated embodiment 134, wherein the at least one cathode active material layer is reversibly compressible.

Enumerated embodiment 136. The method of enumerated embodiment 134, wherein the at least one cathode active material layer is at least partially irreversibly compressible.

Enumerated embodiment 137. The method according to any of enumerated embodiments 134-136, wherein the at the least one cathode active material layer has a lower electrical resistance after the one or more electrochemical formation cycles.

Enumerated embodiment 138. The method according to any of enumerated embodiments 134-137, wherein at least one separator includes a ceramic material.

Enumerated embodiment 139. A lithium-ion battery cell including:
an electrode assembly including:
   a) at least one anode including an anode current collector and a first silicon-containing anode active material layer provided on a first side of the anode current collector and a second silicon-containing anode active material layer provided on a second side of the anode current collector, wherein at least one of the first and second silicon-containing anode active material layers is deposited by a PVD or CVD process and includes at least 85 atomic % silicon;
   b) at least one cathode including a cathode current collector and a first cathode active material layer provided on a first side of the cathode current collector and a second cathode active material layer provided on a second side of the cathode current collector; and
   c) a solid-state electrolyte layer provided between the first cathode active material layer and the first anode active material layer; and
a battery cell housing containing the electrode assembly, the housing including a positive battery terminal for external connection to the at least one cathode and a negative battery terminal for external connection to the at least one anode,
wherein the battery cell includes:
   i) a compressible outer liner provided between the battery cell housing and the electrode assembly;
   ii) a compressible central element around which the electrode assembly is wound;
   iii) a compressible cathode active material layer;
   iv) a compressible current collector structure; or
   v) any combination of (i)-(iv).

Enumerated embodiment 140. A lithium-ion battery cell including:
an electrode assembly including:
   a) an anode including an anode current collector and a first silicon-containing anode active material layer disposed on a first side of the anode current collector, wherein the first silicon-containing anode active material layer includes at least 85 atomic % silicon;
   b) a cathode including a cathode current collector and a first cathode active material layer disposed on a first side of the cathode current collector, wherein the first side of the cathode current collector is proximal to the first side of the anode current collector, and wherein the cathode active material layer is optionally compressible; and
a lithium-ion-containing electrolyte disposed between, and in contact with the anode and cathode; and
a battery cell housing containing the electrode assembly, the housing includes a positive battery terminal in electrical communication with the cathode and a negative battery terminal in electrical communication with the anode,
wherein the first cathode active material layer is configured to be compressible during at least one electrochemical charging event to less than 95% of its thickness prior to the at least one electrochemical charging event.

Enumerated embodiment 141. The battery cell of enumerated embodiment 140, wherein the first cathode active material layer is configured to be compressible to less than 85% of its thickness prior to the at least one electrochemical charging event.

Enumerated embodiment 142. The battery cell of enumerated embodiment 140 or 141, the at least one electrochemical charging event is an initial charging event made as part of an electrochemical formation protocol.

Enumerated embodiment 143. The battery cell according to any of enumerated embodiments 140-142, wherein the first cathode active material layer is configured upon a subsequent electrochemical discharge event to have a thickness of less than or equal to 95% of its thickness prior to the at least one electrochemical charging event.

Enumerated embodiment 144. The battery according to any of enumerated embodiments 144-142, wherein the at least one electrochemical charging event is made during normal battery operation, and wherein the first cathode active material layer is configured such that upon a subsequent electrochemical discharge event, a thickness is restored to greater than 95% of its thickness prior to the at least one electrochemical charging event.

Enumerated embodiment 145. The battery of cell according to any of enumerated embodiments 140-144, wherein the first cathode active material layer has a thickness in a range of 40 to 200 μm prior to the at least one electrochemical charging event.

Enumerated embodiment 146. The battery of cell according to any of enumerated embodiments 140-145, wherein the first cathode active material layer includes a lithium metal oxide compound.

Enumerated embodiment 147. The battery of cell according to any of enumerated embodiments 140-145, wherein the first cathode active material layer includes sulfur, selenium, or both sulfur and selenium.

Enumerated embodiment 148. The battery of cell according to any of enumerated embodiments 140-147, wherein the at least one electrochemical charging event applies a pressure of no more than 100 MPa against the first cathode active material layer.

Enumerated embodiment 149. The battery of cell according to any of enumerated embodiments 140-148, wherein prior to the at least one electrochemical charging event, the first cathode active material layer includes a first sublayer proximal the cathode current collector having a higher density than a second sublayer distal the cathode current collector.

Enumerated embodiment 150. The battery of cell according to any of enumerated embodiments 140-149, wherein the first anode active material layer has a thickness in a range of 4 to 20 μm prior to the at least one electrochemical charging event, and has a thickness in a range of 8 to 60 μm when charged in the at least one electrochemical charging event.

Enumerated embodiment 151. The battery of cell according to any of enumerated embodiments 140-150, wherein the first anode active material layer includes a sub-stoichiometric nitride of silicon, wherein the ratio of N to Si is in a range of 0.02 to 0.10.

Enumerated embodiment 152. The battery of cell according to any of enumerated embodiments 140-151, wherein the first anode active material layer is deposited onto the anode current collector by PECVD, CVD, or PVD.

Enumerated embodiment 153. The battery of cell according to any of enumerated embodiments 140-152, wherein the anode current collector includes a metal foil and is characterized by a tensile strength Rₘ in a range of 500 to 1000 MPa.

Enumerated embodiment 154. The battery of cell according to any of enumerated embodiments 140-153, wherein at least one current collector includes a compressible current collector structure that is configured to be compressible to less than 90% of its thickness prior to the at least one electrochemical charging event, wherein the thickness prior to the at least one electrochemical charging event is in a range of 10 to 30 microns.

Enumerated embodiment 155. The battery cell of enumerated embodiment 154, wherein the compressible current collector structure includes a compressible core, a first electrically conductive layer provided on the compressible core corresponding to the first side of the current collector, and a second electrically conductive layer provided on the compressible core corresponding to a second side of the current collector.

Enumerated embodiment 156. The battery cell of enumerated embodiment 155, wherein the compressible core includes an electrically insulating polymer.

Enumerated embodiment 157. The battery cell of enumerated embodiment 155, wherein the compressible core defines internal bubbles or voids, and wherein the compressible core is electrically insulating.

Enumerated embodiment 158. The battery cell of enumerated embodiment 155, wherein the compressible core defines internal bubbles or voids, and wherein the compressible core is electrically conductive.

Enumerated embodiment 159. The battery of cell according to any of enumerated embodiments 154-158, wherein the compressible current collector structure is configured upon a subsequent electrochemical discharge event to have a thickness of less than or equal to 95% of its thickness prior to the at least one electrochemical charging event.

Enumerated embodiment 160. The battery of cell according to any of enumerated embodiments 154-158, wherein the compressible current collector structure is configured upon a subsequent electrochemical discharge event to have a thickness is restored to greater than 95% of its thickness prior to the at least one electrochemical charging event.

Enumerated embodiment 161. The battery of cell according to any of enumerated embodiments 140-160, wherein the electrolyte is a solid-state electrolyte (SSE).

Enumerated embodiment 162. The battery cell of enumerated embodiment 161, wherein the SSE includes a solid polymer electrolyte, a solid inorganic electrolyte, or a combination thereof.

Enumerated embodiment 163. The battery cell of enumerated embodiment 161 or 162, wherein the SSE includes a solid sulfide electrolyte.

Enumerated embodiment 164. The battery of cell according to any of enumerated embodiments 1-160, wherein the electrolyte is a non-aqueous solvent-based electrolyte.

Enumerated embodiment 165. The battery of cell according to any of enumerated embodiments 140-164, wherein the electrode assembly further includes a first separator disposed between the first cathode active material layer and the first anode active material layer.

Enumerated embodiment 166. The battery cell of enumerated embodiment 165, wherein the first separator is configured to be compressible during the at least one electrochemical charging event from an initial thickness by at least 25%.

Enumerated embodiment 167. The battery cell of enumerated embodiment 165 or 166, wherein the first separator includes a ceramic material.

Enumerated embodiment 168. The battery cell according to any of enumerated embodiments 140-167, wherein:
the anode includes a second silicon-containing anode active material layer disposed on a second side of the anode current collector; and
the cathode includes a second cathode active material layer disposed on a second side of the cathode current collector, wherein the second side of the cathode current collector is distal to the first side of the anode current collector.

Enumerated embodiment 169. The battery cell of enumerated embodiment 168, wherein the electrode assembly further includes a second separator, wherein the cathode is disposed between the first separator and the second separator.

Enumerated embodiment 170. The battery cell of enumerated embodiment 169, wherein the electrode assembly includes a jellyroll structure or a stacked structure.

Enumerated embodiment 171. The battery cell of enumerated embodiment 169 or 170, wherein:
in a cross section, the anode, first separator, cathode, and second separator form a first subunit of the electrode assembly,
the first subunit is a subunit in a plurality of subunits, each subunit including a respective anode, a respective first separator, a respective cathode, and a respective second separator, and
the plurality of subunits is arranged as a stacked structure or as a jellyroll structure.

Enumerated embodiment 172. The lithium-ion battery of enumerated embodiment 171, wherein the plurality of subunits includes at least 5 subunits.

Enumerated embodiment 173. The battery cell according to any of enumerated embodiments 140-172, wherein the housing includes a metal having a thickness in a range of 0.2 mm-1.5 mm, and wherein the battery cell further includes a compressible liner disposed between at least a portion of the housing and the electrode assembly.

Enumerated embodiment 174. The battery cell of enumerated embodiment 173, wherein the compressible liner includes an electrically insulating polymer having a flexural yield strength of less than 10 MPa.

Enumerated embodiment 175. The battery cell of enumerated embodiment 173 or 174, wherein the housing includes a cylindrical or rectangular casing.

Enumerated embodiment 176. The battery cell according to any of enumerated embodiments 140-175, wherein the electrode assembly has a jellyroll structure, and the battery cell further includes a compressible central element around which the jellyroll structure is wound.

Enumerated embodiment 177. The battery cell of enumerated embodiment 176, wherein the compressible central element includes an electrically insulating polymer having a flexural yield strength of less than 10 MPa.

Enumerated embodiment 178. The battery cell according to any of enumerated embodiments 1-111 or 139-177, further comprising at least one compressible current collector, compressible liner, or compressible central element characterized by a flexural yield strength of less than 5 MPa.

Enumerated embodiment 179. A method of making a battery cell, wherein the battery cell is one according to any of enumerated embodiments 139-178, the method including applying one or more electrochemical formation cycles to the battery cell, wherein the battery cell includes at least one compressible element.

Enumerated embodiment 180. The method of enumerated embodiment 179, wherein the at least one compressible element is:
i) a compressible outer liner provided between the battery cell housing and the electrode assembly;
ii) a compressible central element around which the electrode assembly is wound;
iii) a compressible cathode active material layer;
iv) a compressible current collector structure; or
v) a compressible separator.

Enumerated embodiment 181. The method of enumerated embodiment 180, wherein the battery cell comprises a combination of two or more compressible elements selected from (i)-(v).

The specific details of particular embodiments may be combined in any suitable manner without departing from the spirit and scope of embodiments of the invention. However, other embodiments of the invention may be directed to specific embodiments relating to each individual aspect, or specific combinations of these individual aspects. The above description of example embodiments of the invention has been presented for the purposes of illustration and description. It is not intended to be exhaustive or to limit the invention to the precise form described, and many modifications and variations are possible in light of the teaching above.

In the preceding description, for the purposes of explanation, numerous details have been set forth in order to provide an understanding of various embodiments of the present technology. It will be apparent to one skilled in the art, however, that certain embodiments may be practiced without some of these details, or with additional details. Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Additionally, details of any specific embodiment may not always be present in variations of that embodiment or may be added to other embodiments. Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the battery cell” includes reference to one or more battery cells and equivalents thereof known to those skilled in the art, and so forth. The invention has now been described in detail for the purposes of clarity and understanding. However, it will be appreciated that certain changes and modifications may be practice within the scope of the appended claims.

All publications, patents, and patent applications cited herein are hereby incorporated by reference in their entirety for all purposes. None is admitted to be prior art.

1. A lithium-ion battery cell comprising:
an electrode assembly comprising:
a) an anode comprising an anode current collector and a first silicon-containing anode active material layer disposed on a first side of the anode current collector, wherein the first silicon-containing anode active material layer comprises at least 85 atomic % silicon; and
b) a cathode comprising a cathode current collector and a compressible first cathode active material layer disposed on a first side of the cathode current collector, wherein the first side of the cathode current collector is proximal to the first side of the anode current collector;
a lithium-ion-containing electrolyte disposed between, and in contact with the anode and cathode; and
a battery cell housing containing the electrode assembly and electrolyte, the housing comprises a positive battery terminal in electrical communication with the cathode and a negative battery terminal in electrical communication with the anode,
wherein the first cathode active material layer is partially or substantially irreversibly compressible and configured to be compressible during at least one electrochemical charging event to less than 95% of its thickness prior to the at least one electrochemical charging event.

2. The battery cell of claim 1, wherein the first cathode active material layer is configured to be compressible to less than 85% of its thickness prior to the at least one electrochemical charging event.

3. The battery cell of claim 2, wherein the at least one electrochemical charging event is an initial charging event made as part of an electrochemical formation protocol.

4. The battery cell of claim 31, wherein the first cathode active material layer is substantially irreversibly compressible.

5. (canceled)

6. The battery cell of claim 1, wherein the first cathode active material layer has a thickness in a range of 40 to 200 μm prior to the at least one electrochemical charging event.

7. The battery cell of claim 1, wherein the first cathode active material layer comprises a lithium metal oxide compound, or wherein the first cathode active material layer comprises sulfur, selenium, or both sulfur and selenium.

8. (canceled)

9. The battery cell of claim 1, wherein the at least one electrochemical charging event applies a pressure of no more than 100 MPa against the first cathode active material layer.

10. The battery cell of claim 1, wherein prior to the at least one electrochemical charging event, the first cathode active material layer comprises a first sublayer proximal the cathode current collector having a higher density than a second sublayer distal the cathode current collector.

11. The battery cell of claim 1, wherein the first anode active material layer has a thickness in a range of 4 to 20 μm prior to the at least one electrochemical charging event, and has a thickness in a range of 8 to 60 μm when charged in the at least one electrochemical charging event.

12. The battery cell of claim 1, wherein the first anode active material layer comprises a sub-stoichiometric nitride of silicon, wherein a ratio of N to Si is in a range of 0.02 to 0.10.

13. The battery cell of claim 1, wherein the first anode active material layer is deposited onto the anode current collector by PECVD, CVD, or PVD.

14. The battery cell of claim 1, wherein the anode current collector comprises a metal foil and is characterized by a tensile strength Rₘ in a range of 500 to 1000 MPa.

15. The battery cell of claim 1 or 2, wherein at least one current collector comprises a compressible current collector structure that is configured to be compressible to less than 90% of its thickness prior to the at least one electrochemical charging event, wherein the thickness prior to the at least one electrochemical charging event is in a range of 10 to 30 microns.

16. The battery cell of claim 15, wherein the compressible current collector structure comprises a compressible core, a first electrically conductive layer provided on the compressible core corresponding to the first side of the current collector, and a second electrically conductive layer provided on the compressible core corresponding to a second side of the current collector.

17. The battery cell of claim 16, wherein the compressible core comprises an electrically insulating polymer.

18. The battery cell of claim 16, wherein the compressible core defines internal bubbles or voids, and wherein the compressible core is electrically insulating.

19. The battery cell of claim 16, wherein the compressible core defines internal bubbles or voids, and wherein the compressible core is electrically conductive.

20. The battery cell of claim 15, wherein the compressible current collector structure is configured upon a subsequent electrochemical discharge event to have a thickness of less than or equal to 95% of its thickness prior to the at least one electrochemical charging event.

21. The battery cell of claim 15, wherein the compressible current collector structure is configured upon a subsequent electrochemical discharge event to have a thickness restored to greater than 95% of its thickness prior to the at least one electrochemical charging event.

22-25. (canceled)

26. The battery cell of claim 1, wherein the electrode assembly further comprises a first separator disposed between the first cathode active material layer and the first anode active material layer, wherein the first separator is configured to be compressible during the at least one electrochemical charging event from an initial thickness by at least 25%.

27-28. (canceled)

29. The battery cell of claim 261, wherein:
i) the anode comprises a second silicon-containing anode active material layer disposed on a second side of the anode current collector;
ii) the cathode comprises a second cathode active material layer disposed on a second side of the cathode current collector, wherein the second side of the cathode current collector is distal to the first side of the anode current collector;
iii) the battery cell further comprises a first separator disposed between the first cathode active material layer and the first anode active material layer, and a second separator wherein the cathode is disposed between the first separator and the second separator; and
iv) the electrode assembly comprises a jellyroll structure or a stacked structure.

30-33. (canceled)

34. The battery cell of claim 29, wherein the housing comprises a metal having a thickness in a range of 0.2 mm-1.5 mm, and wherein the battery cell further comprises a compressible liner disposed between at least a portion of the housing and the electrode assembly, wherein the compressible liner comprises an electrically insulating polymer having a flexural yield strength of less than 10 MPa.

35-36. (canceled)

37. The battery cell of claim 29, wherein the electrode assembly has a jellyroll structure, and the battery cell further comprises a compressible central element around which the jellyroll structure is wound, and wherein the compressible central element comprises an electrically insulating polymer having a flexural yield strength of less than 10 MPa.

38-40. (canceled)
